(19) United States
(12) Patent Application Publication
(10) Pub. No.: US 2025/0040667 A1
(43) Pub. Date: Feb. 6, 2025

(54) WEARABLE ACCESSORY WITH INTEGRATED LIQUID CONTAINER

(71) Applicant: Daniel Koren, Miami, FL (US)

(72) Inventor: Daniel Koren, Miami, FL (US)

(21) Appl. No.: 18/920,960

(22) Filed: Oct. 20, 2024

Related U.S. Application Data
(63) Continuation-in-part of application No. 18/314,877, filed on May 10, 2023, now Pat. No. 12,121,119.
Application No. 18/314,877 is a continuation of application No. 17/811,069, filed on Jul. 6, 2022, now Pat. No. 11,659,900.

(51) Int. Cl. A44C 5/00; A45D 34/00; B05B 11/10; B05B 15/62

(52) U.S. Cl. CPC A44C 5/003; A45D 34/00; B05B 11/1001; B05B 15/62; A45D 2034/007; A45D 2200/057

(57) ABSTRACT

A wearable accessory for storing and dispensing liquid and a method of using the same are described. The accessory can include a housing having a through-hole configured to receive a hand of a user, and a liquid container enclosed within the housing. The liquid container can include a first end having a sealable opening for adding liquid for storing and dispensing, and a second end in fluid communication with a sprayer that is recessed with respect to an external surface of the housing. The accessory can include a closure for sealing the sealable opening. The closure and sprayer are concealed by a cover in a closed position, the sprayer is accessible in an intermediate position, and the closure and sprayer are accessible in an open position. The cover can be a slidable cover that slides from the closed position to the intermediate position or the open position.

### CROSS-REFERENCE TO RELATED APPLICATIONS

This is a continuation-in-part of U.S. patent application Ser. No. 18/314,877 filed on May 10, 2023, which is a continuation of U.S. patent application Ser. No. 17/811,069 filed on Jul. 6, 2022, which claims the benefit of priority under 35 U.S.C. § 119(e) of U.S. Provisional Application Ser. No. 63/218,630 filed on Jul. 6, 2021, the contents of which are relied upon and incorporated herein by reference in their entireties.

### FIELD

The present disclosure generally relates to an article of apparel, and more particularly to a wearable accessory (e.g., bracelet) comprising an integrated liquid container having a spraying mechanism for dispensing liquid out of the accessory.

### BACKGROUND

Bracelets and other ornamental bands that are worn around a user's wrist are common accessories. Those who wear such accessories may not carry a bag or wear clothing that can accommodate a liquid dispenser (e.g., a bottle of hand sanitizer). For at least these reasons, there is a need for a device that can function as a wearable accessory and a liquid dispenser.

### SUMMARY

In various embodiments, a wearable accessory for storing and dispensing liquid is provided. In some embodiments, the wearable accessory comprises: a wearable housing comprising a through-hole configured to receive a hand of a user therethrough, the through-hole being sized for the user's lower arm; a liquid container having a structure independent from the wearable housing, and enclosed within an internal space defined by the wearable housing, the liquid container comprising a first end having a sealable opening for adding liquid for the storing and dispensing, and a second end in fluid communication with a sprayer recessed in the wearable housing; and a closure configured to seal the sealable opening on the first end of the liquid container; and a recess cover adapted for the wearable housing and configured to move between a closed position that conceals the sprayer and the closure and an open position that allows access to the sprayer and the closure.

In some embodiments, the recess cover is a slidable cover that is configured to slide along an external surface of the wearable housing between the closed position and the open position.

In some embodiments, the slidable cover comprises one or more detents projecting from an internal surface facing the wearable housing when assembled, and the wearable housing comprises one or more indents configured to receive the one or more detents when the slidable cover slides between the closed position and the open position.

In some embodiments, the wearable housing comprises one or more detents projecting from a surface facing the recess cover when assembled, and the slidable cover comprises one or more indents configured to receive the one or more detents when the slidable cover slides between the closed position and the open position.

In some embodiments, the recess cover is configured to move between the closed position, the open position, and an intermediate position that allows access to the sprayer but not the closure.

In some embodiments, the wearable housing comprises a generally circular or oval cross-sectional shape and the slidable cover comprises a generally semi-circular cross-sectional shape.

In some embodiments, the recess cover comprises one or more magnets or ferromagnetic materials; wherein the wearable housing comprises one or more magnets or ferromagnetic materials; and wherein the recess cover is in the closed position when the one or more magnets or ferromagnetic materials on the recess cover are in contact with the one or more magnets or ferromagnetic materials on the wearable housing, and in the open position when the one or more magnets or ferromagnetic materials on the recess cover are not in contact with the one or more magnets or ferromagnetic materials on the wearable housing.

In some embodiments, the recess cover is coupled to the wearable housing with a hinge, and the recess cover pivots about the hinge between the closed position and the open position.

In some embodiments, the liquid container comprises a shape adapted for the wearable housing, whereby the liquid container is immobilized within the wearable housing due to its positioning between a plurality of perimeter edges on the wearable housing.

In some embodiments, the sprayer comprises a dip tube for drawing the volume of liquid from the liquid container.

In some embodiments, the recess cover comprises a shape corresponding to an external shape of the wearable housing and the recess cover is coupled to the wearable housing using compression forces provided by the shape of the recess cover.

In some embodiments, the recess cover comprises a shape corresponding to an external shape of the wearable housing, and the recess cover is coupled to the wearable housing using a combination of magnets or ferromagnetic materials, a combination of detents and indents configured to receive the detents, or a combination of detents and a channel configured to receive the detents.

In some embodiments, the through-hole comprises a generally cylindrical shape having a circumference ranging from about 5.5 to about 10 inches.

In some embodiments, the through-hole comprises a generally cylindrical shape having a circumference ranging from about 7 to about 9 inches.

In some embodiments, the wearable accessory comprises a lock integrated into the wearable housing, wherein the lock is movable from a locked position to an unlocked position, and wherein the locked position prevents the recess cover from moving from the closed position to the open position.

In various embodiments, the wearable accessory comprises: a wearable housing comprising a through-hole configured to receive a hand of a user therethrough, the through-hole being sized for the user's lower arm; a liquid container having a structure independent from the wearable housing, and enclosed within an internal space defined by the wearable housing, the liquid container comprising a first end having a sealable opening for adding liquid for the storing and dispensing, and a second end in fluid communication with a sprayer recessed in the wearable housing; and a closure configured to seal the sealable opening on the first end of the liquid container; and a slidable cover adapted for the wearable housing and configured to slide about an external surface on the wearable housing between a closed position that conceals the sprayer and the closure and an open position that allows access to the sprayer and the closure.

In various embodiments, a method of applying a liquid to a surface is provided. In some embodiments, the method comprises: providing a wearable accessory for storing and dispensing a liquid, the wearable accessory comprising: a wearable housing comprising a through-hole configured to receive a hand of a user therethrough, the through-hole being sized for the user's lower arm; a liquid container having a structure independent from the wearable housing, and enclosed within an internal space defined by the wearable housing, the liquid container comprising a first end having a sealable opening for adding liquid for the storing and dispensing, and a second end in fluid communication with a sprayer recessed in the wearable housing; a volume of liquid stored inside the liquid container; and a closure configured to seal the sealable opening on the first end of the liquid container; and a recess cover adapted for the wearable housing and configured to move between a closed position that conceals the sprayer and the closure and an open position that allows access to the sprayer and the closure; moving the recess cover to the open position; directing an opening in the sprayer toward the surface; and actuating the sprayer to cause a portion of the volume of liquid stored inside the liquid container to exit the opening in the sprayer.

In various embodiments, a wearable accessory for storing and dispensing liquid is provided. In some embodiments, the accessory comprises a wearable housing comprising a loop structure with a through-hole configured to receive a hand of a user therethrough, the through-hole being sized for the user's lower arm; and a liquid container enclosed within the housing, the liquid container comprising a first end having a sealable opening for adding liquid for the storing and dispensing, and a second end in fluid communication with a nozzle opening recessed in an external surface on the front side of the housing; wherein the nozzle opening is configured to receive and dispense a volume of atomized liquid from a sprayer coupled to the second end of the liquid container when the sprayer is activated by an actuator integrated into the housing; and wherein the recessed nozzle opening prevents the user from contacting the sprayer.

In some embodiments, the first end of the liquid container is concealed within the housing by a detachable cap cover that is removably attached to the housing.

In some embodiments, the liquid container further comprises a removable cap, and the opening on the first end of the liquid container is configured to be coupled to the removable cap.

In some embodiments, the liquid container comprises a shape adapted for the housing, whereby the liquid container is immobilized within the housing due to its positioning between a plurality of perimeter edges on the housing and the through-hole.

In some embodiments, the actuator comprises a block-like structure having an outward facing surface that is accessible to the user as a push button on a top surface of the accessory and an inward facing surface that slides toward and contacts the sprayer when the actuator is activated by a user.

In some embodiments, the actuator comprises a channel extending from an opening in a first actuator surface to an opening in an adjacent second actuator surface, wherein the channel is in fluid communication with the sprayer via the opening in the first actuator surface and in fluid communication with the nozzle opening recessed in the front side of the housing via the opening in the adjacent second actuator surface.

In some embodiments, the opening at the first end of the liquid container is concealed within the housing by a detachable cap cover that is removably attached to a rear side of the housing opposite the front side.

In some embodiments, the wearable accessory further comprises a lock integrated into the housing, wherein the lock is slidable from a locked position to an unlocked position, and wherein the lock in the locked position prevents the actuator from activating the sprayer.

In various embodiments, a method of applying a fragrance to a surface is provided. In some embodiments, the method comprises the steps of providing a wearable accessory for storing and dispensing fragrance containing liquid, the accessory comprising: a wearable housing comprising a loop structure with a through-hole configured to receive a hand of a user therethrough, the through-hole being sized for the user's lower arm; and a liquid container enclosed within the housing, the liquid container comprising a first end having a sealable opening for adding liquid for the storing and dispensing, and a second end in fluid communication with a nozzle opening recessed in an external surface on the front side of the housing; wherein the nozzle opening is configured to receive and dispense a volume of atomized liquid from a sprayer coupled to the second end of the liquid container when the sprayer is activated by an actuator integrated into the housing; wherein the recessed nozzle opening prevents the user from contacting the sprayer; and wherein the liquid container is filled with a volume of a fragrance containing liquid; actuating the actuator of the accessory, whereby the actuating causes liquid inside of the liquid container to be drawn through a dip tube to an interior of a sprayer housing; and further actuating the actuator pumps the liquid upward through a piston toward the actuator before the liquid exits the nozzle opening.

In some embodiments, the surface is human skin.

In some embodiments, the first end of the liquid container is concealed within the housing by a detachable cap cover that is removably attached to the housing.

In some embodiments, the liquid container further comprises a removable cap, and the opening on the first end of the liquid container is configured to be coupled to the removable cap.

In some embodiments, the liquid container comprises a shape adapted for the housing, whereby the liquid container is immobilized within the housing due to its positioning between a plurality of perimeter edges on the housing and the through-hole.

In some embodiments, the actuator comprises a block-like structure having an outward facing surface that is accessible to the user as a push button on a top surface of the accessory and an inward facing surface that slides toward and contacts the sprayer when the actuator is activated by a user.

In some embodiments, the actuator comprises a channel extending from an opening in a first actuator surface to an opening in an adjacent second actuator surface, wherein the channel is in fluid communication with the sprayer via the opening in the first actuator surface and in fluid communication with the nozzle opening recessed in the front side of the housing via the opening in the adjacent second actuator surface.

In some embodiments, the opening at the first end of the liquid container is concealed within the housing by a detachable cap cover that is removably attached to a rear side of the housing opposite the front side.

In various embodiments, a method of sanitizing a surface is provided. In some embodiments, the method comprises the steps of providing a wearable accessory for storing and dispensing sanitizing liquid, the accessory comprising: a wearable housing comprising a loop structure with a through-hole configured to receive a hand of a user therethrough, the through-hole being sized for the user's lower arm; and a liquid container enclosed within the housing, the liquid container comprising a first end having a sealable opening for adding liquid for the storing and dispensing, and a second end in fluid communication with a nozzle opening recessed in an external surface on the front side of the housing; wherein the nozzle opening is configured to receive and dispense a volume of atomized liquid from a sprayer coupled to the second end of the liquid container when the sprayer is activated by an actuator integrated into the housing; wherein the recessed nozzle opening prevents the user from contacting the sprayer; and wherein the liquid container is filled with a volume of sanitizing liquid; actuating the actuator of the accessory, whereby the actuating causes liquid inside of the liquid container to be drawn through a dip tube to an interior of a sprayer housing; and further actuating the actuator pumps the liquid upward through a piston toward the actuator before the liquid exits the nozzle opening.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein and, together with the description, explain the principles and operations of the claimed subject matter.

### BRIEF DESCRIPTION OF THE DRAWINGS

A complete understanding of the present embodiments and the advantages and features thereof will be more readily understood by reference to the following detailed description, appended claims, and accompanying drawings, wherein:

FIG. 1 is a rear perspective view of a wearable accessory, in accordance with some embodiments described herein;

FIG. 2 is a side view of the wearable accessory of FIG. 1;

FIG. 3 is a front view of the wearable accessory of FIG. 1;

FIG. 4 is a front perspective view of the wearable accessory of FIG. 1;

FIG. 5 is a top view of the wearable accessory of FIG. 1;

FIG. 6 is a cross-sectional side view of the wearable accessory in FIG. 1, taken along the X-X′ line in FIGS. 2 and 5, with the actuator in an inactive position;

FIG. 7 is a cross-sectional view of a wearable accessory having a locking mechanism and an alternative integrated spray bottle and cap cover placement, in accordance with some embodiments described herein;

FIG. 8 is a cross-sectional side view of the wearable accessory in FIG. 6, with the actuator in an active position, and showing a user activating the actuator for environmental context;

FIG. 9 is a perspective view of a wearable accessory having an alternative shape, in accordance with some embodiments described herein;

FIG. 10 is a perspective view of a wearable accessory having an alternative shape, in accordance with some embodiments described herein;

FIG. 11 is a perspective view of a wearable accessory having an alternative shape, in accordance with some embodiments described herein;

FIG. 12 is a perspective view of a wearable accessory having an alternative shape, in accordance with some embodiments described herein;

FIG. 13 is a perspective environmental view showing a user wearing and activating the wearable accessory of FIG. 1;

FIG. 14A is a side view of a wearable accessory with a slidable cover in a closed position, in accordance with some embodiments described herein; FIG. 14B is a side view of the wearable accessory of FIG. 14A with a slidable cover in an open position; FIG. 14C is a side view of the wearable accessory of FIG. 14B with a closure removed from a sealable opening of a liquid container contained within a housing of the wearable accessory; FIG. 14D is a side view of the wearable accessory of FIG. 14C, with a refill bottle approaching the sealable opening; and FIG. 14E is a side view of the wearable accessory of FIG. 14D, with the refill bottle inserted into the sealable opening;

FIG. 15A is a cross-sectional view taken about the V-V′ line of the wearable accessory of FIG. 14A; FIG. 15B is a cross-sectional view taken about the W-W′ line of the wearable accessory of FIG. 14B; FIG. 15C is a cross-sectional view taken about the X-X′ line of the wearable accessory of FIG. 14C; FIG. 15D is a cross-sectional view taken about the Y-Y′ line of the wearable accessory of FIG. 14D; FIG. 15E, FIG. 15F, and FIG. 15G are cross-sectional views taken about the Z-Z′ line of the wearable accessory of FIG. 14E; FIG. 15H is a cross-sectional view taken about the X-X′ line of the wearable accessory of FIG. 14C; FIG. 15J is a cross-sectional view taken about the V-V′ line of the wearable accessory of FIG. 14A;

FIG. 16A is an exploded view of a liquid container, sprayer, and closure, in accordance with some embodiments described herein; FIG. 16B and FIG. 16C are partially exploded views of the liquid container of FIG. 16A; and FIG. 16D is an assembled liquid container, sprayer, and closure, in accordance with some embodiments described herein;

FIG. 17A is an exploded view of a wearable accessory, in accordance with some embodiments described herein; FIG. 17B, FIG. 17C, and FIG. 17D are partially exploded views of the wearable accessory of FIG. 17A;

FIG. 18A is a perspective view of a liquid container and a sprayer in a first position, in accordance with some embodiments described herein; FIG. 18B is an exploded view of the liquid container and sprayer of FIG. 18A; FIG. 18C is a perspective view of the liquid container and sprayer of FIG. 18A with the sprayer in a second position;

FIG. 19A is an exploded view of a wearable accessory, in accordance with some embodiments described herein; FIG. 19B and FIG. 19C are partially exploded views of the wearable accessory of FIG. 19A; and FIG. 19D is a perspective view of the wearable accessory of FIG. 19A after assembly;

FIG. 20A is a perspective view of a wearable accessory with a slidable cover in a first position, in accordance with some embodiments described herein; FIG. 20B is a perspective view of the wearable accessory of FIG. 20A with the slidable cover in a second position; and FIG. 20C is a partially exploded view of the wearable accessory of FIG. 20A;

FIG. 21A, FIG. 21B, and FIG. 21C are cross-sectional views taken about the VV-VV' line of the wearable accessory of FIG. 20A showing the slidable cover in different positions relative to the housing;

FIG. 22A is a perspective view of a wearable accessory with a slidable cover in a first position, in accordance with some embodiments described herein; FIG. 22B is a perspective view of the wearable accessory of FIG. 22A with the slidable cover in a second position; and FIG. 22C is a partially exploded view of the wearable accessory of FIG. 22A;

FIG. 23A and FIG. 23B are cross-sectional views taken about the XX-XX′ line of the wearable accessory of FIG. 22A showing the slidable cover in different positions relative to the housing;

FIG. 24A is a perspective view of a housing for a wearable accessory, in accordance with some embodiments described herein; FIG. 24B is a perspective view of a slidable cover for the wearable accessory of FIG. 24A; and FIG. 24C is an exploded view of the housing of FIG. 24A and the slidable cover of FIG. 24B prior to assembly;

FIG. 25A is cross-sectional view of a wearable accessory having side detents on the housing pressed against the interior side of a slidable cover, in accordance with some embodiments described herein; and FIG. 25B is a cross-sectional view of a wearable accessory having side detents on the housing engaged with indents on the interior side of a slidable cover, in accordance with some embodiments described herein;

FIG. 26A is cross-sectional view of a wearable accessory having spring-loaded side detents on the housing pressed against the interior side of a slidable cover, in accordance with some embodiments described herein; and FIG. 26B is a cross-sectional view of a wearable accessory having spring-loaded side detents on the housing engaged with indents on the interior side of a slidable cover, in accordance with some embodiments described herein;

FIG. 27A is a perspective view of a wearable accessory with a slidable cover coupled to a track in the housing in a closed position, in accordance with some embodiments described herein; FIG. 27B is a perspective view of the wearable accessory of FIG. 27A with the slidable cover coupled to the track in the housing in an open position; FIG. 27C is a partially exploded view of the wearable accessory of FIG. 27A; FIG. 27D is a ghost side view of the wearable accessory of FIG. 27A showing the detents of the slidable cover engaged with the track of the housing and the slidable cover in a closed position; FIG. 27E is a ghost side view of the wearable accessory of FIG. 27A showing the detents of the slidable cover engaged with the track of the housing and the slidable cover in a partially open and closed position; and FIG. 27F is a ghost side view of the wearable accessory of FIG. 27A showing the detents of the slidable cover engaged with the track of the housing and the slidable cover in an open position;

FIG. 28A is a side view of a wearable accessory having an oval shape and a slidable cover in a closed position, in accordance with some embodiments described herein; FIG. 28B is side view of the wearable accessory of FIG. 28A with the slidable cover in an open position; FIG. 28C is a perspective view of the wearable accessory of FIG. 28A; and FIG. 28D is partially exploded view of the wearable assembly of FIG. 28A with the slidable cover removed;

FIG. 29A is a perspective view of a wearable accessory with a slidable cover coupled to the housing having a lock in a locked position, in accordance with some embodiments described herein; FIG. 29B is a perspective view of the wearable accessory of FIG. 29A having the lock in an unlocked position; and FIG. 29C is a perspective view of the wearable accessory of FIG. 29B with the slidable cover in an open position that exposes the sprayer;

FIG. 30A is an exploded view of a friction slider cover, in accordance with some embodiments described herein; and FIG. 30B is a perspective view of the friction slider of FIG. 30A after assembly;

FIG. 31 is a perspective view of a slidable cover with a locking detent, in accordance with some embodiments described herein;

FIG. 32A is a perspective view of a wearable accessory with a magnetic cover coupled to the housing, in accordance with some embodiments described herein; and FIG. 32B is a perspective view of the wearable accessory of FIG. 32A with the magnetic cover decoupled from the housing to expose a sprayer;

FIG. 33A is a perspective view of a wearable accessory with a hinged cover in a first position, in accordance with some embodiments described herein; and FIG. 33B is a perspective view of the wearable accessory of FIG. 33A with the hinged cover in a second position that exposes a sprayer; and

FIG. 34A is a perspective view of a wearable accessory with a slidable cover in a first position, in accordance with some embodiments described herein; and FIG. 34B is a perspective view of the wearable accessory of FIG. 34A with the slidable cover in a second position that exposes a roller applicator.

The drawings are not necessarily to scale, and certain features and certain views of the drawings may be shown exaggerated in scale or in schematic in the interest of clarity and conciseness.

### DETAILED DESCRIPTION

Reference will now be made in detail to the exemplary embodiment(s), examples of which is/are illustrated in the accompanying drawings. Whenever possible, the same reference characters will be used throughout the drawings to refer to the same or like parts.

Before describing the exemplary embodiments, it is noted the embodiments reside primarily in combinations of components and procedures related to the accessory. Accordingly, the accessory components have been represented where appropriate in the drawings, showing only those specific details that are pertinent to understanding the embodiments of the present disclosure so as not to obscure the disclosure with details that will be readily apparent to those of ordinary skill in the art having the benefit of the description herein.

The specific details of the various embodiments described herein are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

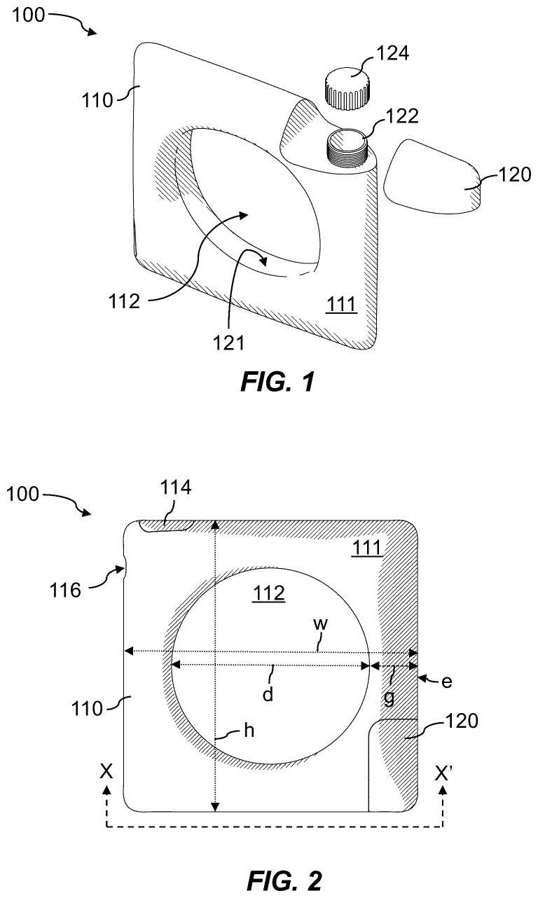

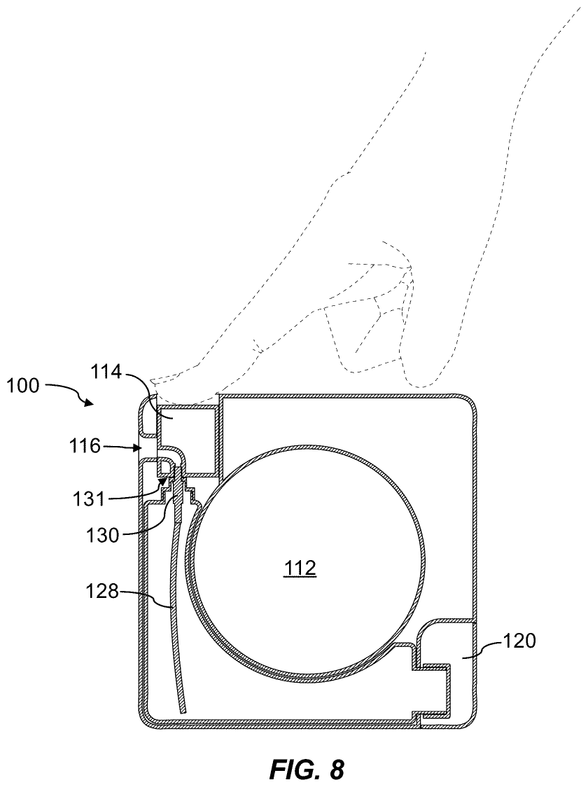

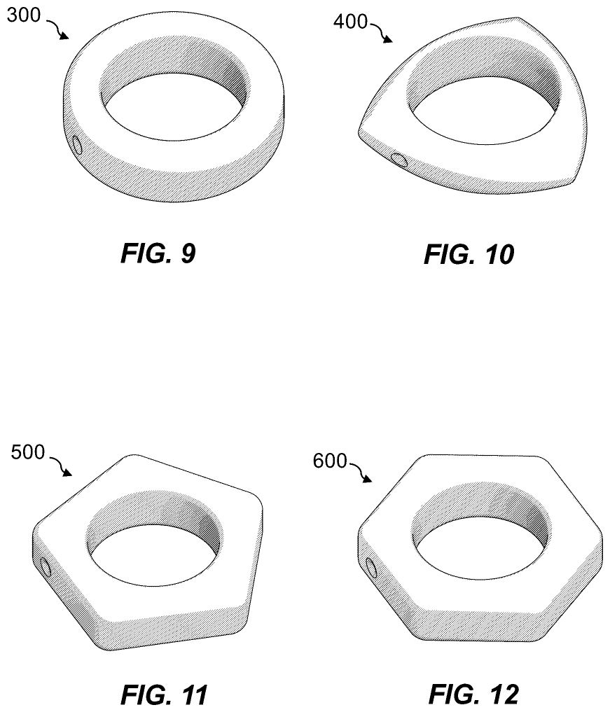

In various embodiments, as shown in FIGS. 1-34B, a wearable accessory is provided. The wearable accessory is sized and configured to be worn by a user, including, for example, on the user's wrist or ankle. The wearable accessory is configured to house a container for containing liquid and a mechanism for atomizing and spraying the liquid out of the accessory in a controlled manner, in a predetermined amount, and in a predetermined direction.

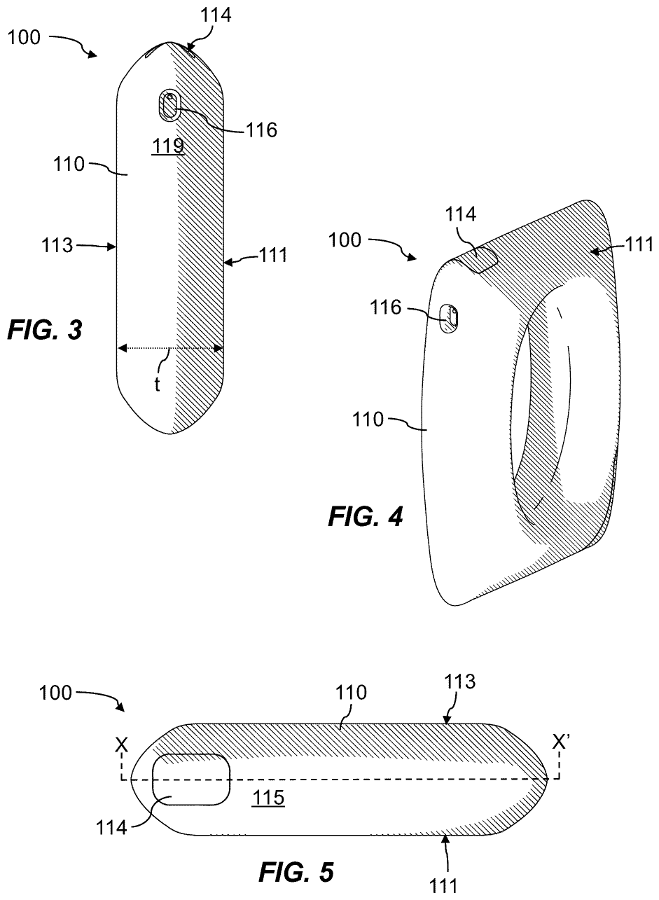

In some embodiments, as shown in FIGS. 1-6, 8, and 13, the accessory 100 is provided. In such embodiments, the accessory 100 comprises the housing 110. In some embodiments, the housing 110 comprises a three-dimensional structure comprising the first face 111, the second face 113 opposite the first face 111, and the through-hole 112 extending between the first face 111 to the second face 113. In some embodiments, the through-hole 112 is positioned in the center or center portion of the housing 110 to define a generally ring-like shape. In this context, the term “generally ring-like” includes circular and non-circular shapes forming a wearable loop or band with a through-hole in the center or center portion, as shown in FIG. 2. In some embodiments, the housing 110 forms a closed loop or band with no gaps in the generally ring-like structure. In some embodiments, the housing 110 forms an open loop or band structure having a circumferential gap in the generally ring-like structure. In some embodiments, the positioning of the through-hole 112 in the center or center portion of the housing 110 provides a symmetrical shape for the three-dimensional structure.

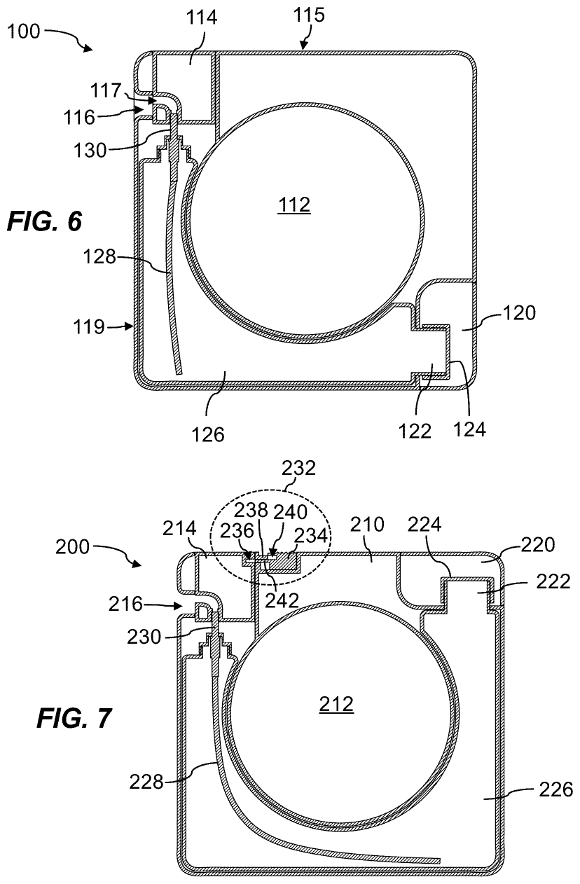

The accessory 100 can be any suitable size and shape. In this context, the suitability of the size and shape is based on the wearability of the accessory 100 for a user (i.e., human), and the term “wearability” refers to the comfort and overall profile of the accessory 100. Referring to FIGS. 2 and 3, the accessory 100 comprises a predetermined width (w), height (h), and thickness (t). As shown in FIG. 2, the distances between opposite edges of the accessory 100 define the width (w) and height (h), respectively. As shown in FIG. 3, the distance between the first face 111 and the second face 113 defines the thickness (t). In some embodiments, the width and height are the same. In other embodiments, the width and height are different. In various embodiments, the width (w) and height (h) range from about 2 to about 5 inches (″), including, e.g., 2.5″, 2.75″, 3″, 3.25″, 3.5″, 3.75″, 4″, 4.25″, 4.5″, etc.

The through-hole 112 can be any suitable size and shape. In some embodiments, the through-hole 112 has a cylindrical shape with a circular cross-sectional profile, as shown in FIGS. 1-13. In such embodiments, the cylindrical shape provides a smooth interior surface 121 that facilitates the ability of the through-hole 112 to receive a body part of the user. In some embodiments, for example, the accessory 100 is a bracelet and the smooth interior surface 121 defining the through-hole 112 will facilitate the insertion of the user's hand through the through-hole 112, and further accommodate the user's wrist and lower arm (i.e., the portion of the arm extending between and including the elbow and the wrist) so the accessory 100 can be slidably adjusted up and down the user's arm. In some embodiments, shapes other than cylindrical are contemplated for the through-hole 112, including, for example, a generally cylindrical shape having beveled circumferential edges near the first and second faces 111, 113.

In some embodiments, the accessory 100 is a bracelet. Users generally have a wrist circumference (c) ranging from about 5 to about 9 inches (″), including, e.g., 5.5″, 6″, 6.5″, 7″, 7.5″, 8″, 8.5″. In some embodiments, the through-hole 112 of the accessory 100 comprises a circumference (c) ranging from about 5.5 to about 10 inches, or between about 7 and about 9 inches, including, e.g., 6″, 6.5″, 7″, 7.5″, 8″, 8.5″, 9″, 9.5″, to accommodate the user's wrist. The stated ranges include any subranges thereof, as well as the intermediate points (e.g., 6.2″, 6.29″, 6.4″, 6.79″, 7.1″, 7.29″, 7.9″, 8.29″, 8.4″, 8.79″, 9.28″. Each circumference (c) has a corresponding diameter (d). For example, a through-hole 112 having a circumference of 8.29″ will have a corresponding diameter (d) of 2.625″. One skilled in the art would appreciate how to calculate the corresponding diameter (d) for any circumference using the formula: d=c/π.

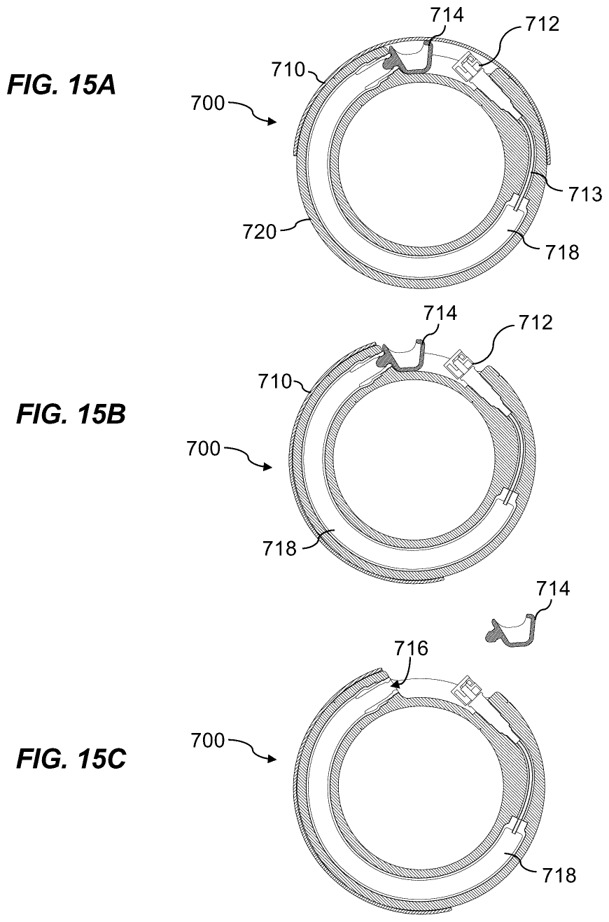

In some embodiments, as shown in FIG. 2, the accessory 100 comprises a spaced distance (g) between the through-hole 112 and the edge (e). In some embodiments, the spaced distance (g) ranges from about 0.25 to about 1.5 inches (″), including, e.g., 0.4375″, 0.5″, 0.5625″, 0.6″, 0.625″, 0.6875″, 0.7″, 0.8″, 0.9″, 1.0″ etc. In some embodiments, the spaced distance (g) between the through-hole 112 and the edge (e) is identical for the entire perimeter edge (e) of the accessory. In such embodiments, the accessory would have a tubular shape, such as accessory 300 in FIG. 9. In other embodiments, the spaced distance (g) between the through-hole 112 and the edge (e) is not identical for the entire perimeter surface of the accessory. In such embodiments, two or more different spaced distances (g) between the through-hole 112 and the edge (e) may be used to create various shapes, such as the accessories 100, 400, 500, and 600 in FIGS. 1 and 9-12, respectively.

In some embodiments, the accessory 100 comprises one or more components integrated into the housing 110, including the detachable cap cover 120. In some embodiments, the detachable cap cover 120 is a shell having a size, shape, and overall profile that corresponds to the size, shape, and overall profile of the housing 110. In some embodiments, the cap cover 120 is removably coupled to the housing 110. In FIG. 1, for example, the cap cover 120 is detached from the accessory 100, whereas FIGS. 2, 4, and 13 show the cap cover 120 attached to the accessory 100 to conceal the removable cap 124 and the mouth 122. In such embodiments, the cap cover 120 has a size, shape, and overall profile that corresponds to the size, shape, and overall profile of the housing 110. In some embodiments, the cap cover 120 is slidably removable from the housing 100, whereby the cap cover 120 can be slid into position on the housing 100 to complete the overall structure of the accessory 100. In some embodiments, the cap cover 120 and the housing 100 make a clicking sound to indicate the cap cover 120 has been secured into its proper position. In some embodiments, the cap cover 120 can include one or more clips that can snap into one or more corresponding slots in the housing 110 to provide a reinforced closure. In some embodiments, the cap cover 120 can be pivotably attached to the housing 110 using a hinge. In such embodiments, the detachable cap cover 120 can be flipped open about the hinge to provide access to the removeable cap 124 and mouth 122 concealed within, while also keeping the detachable cap cover 120 coupled to the housing 110.

The detachable cap cover 120 can be positioned on the housing 110 of the accessory 100 in any suitable place. In some embodiments, the housing 110 has a shape with corners or points, and the cap cover 120 can be positioned on one of the corners/points. For example, the accessory 100 in FIG. 1 has a generally rectangular prism shape with four corners (and a square perimeter cross-sectional shape), and the cap cover 120 is positioned at and configured as one of the four corners. In some embodiments, the housing 110 comprises a shape having no corners or points, such as a circular ring structure. In such embodiments, the detachable cap cover 120 can be positioned on the housing 110 at the position corresponding to the location of the mouth 122 and removable cap 124. In such embodiments, the cap cover 120 can be snapped in and out of position as needed.

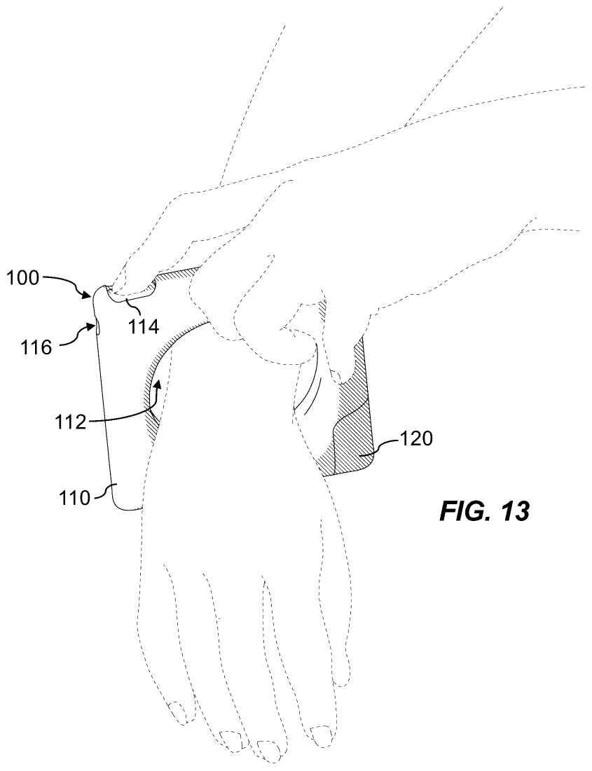

In some embodiments, the accessory 100 comprises the liquid container 126, which is integrated within the housing 110. In some embodiments, the housing 110 includes an interior, hollowed-out space for the liquid container 126. In some embodiments, the liquid container 126 is integrated into a filled interior space. In such embodiments, the liquid container 126 is sized and configured to correspond to the internal size, shape, and profile of the housing 110. In some embodiments, as shown in FIG. 6, for example, the liquid container 126 comprises a general elbow shape that extends along two perimeter edges of the housing 110 and the internal edge defined by the circumference of the through-hole 112.

In some embodiments, as shown in FIGS. 1 and 6, the liquid container 126 comprises the mouth 122 at a first end though which a volume of liquid can be added or removed to fill or empty the liquid container. In such embodiments, the liquid container 126 further comprises the corresponding removeable cap 124, and the mouth 122 is configured to receive the removeable cap 124. The mouth 122 can be removably coupled to the removeable cap 124 using any suitable means. In this context, a suitable coupling requires a liquid-tight seal while the mouth 122 is coupled to the removeable cap 124, and further allows the user to remove and reseal the removeable cap 124 without any specialized tool. In some embodiments, for example, the mouth 122 comprises a threaded external surface that is configured to couple with a corresponding threaded internal surface of the removeable cap 124 (i.e., a screw cap). Other suitable couplings are contemplated. For example, one of skill in the art would appreciate that other suitable closures can be implemented, including, for example, snap on closures, friction fit closures, sports cap style closures, bail closures, bung type closures, etc. In some embodiments, when secured in place, the removeable cap 124 entirely obscures the visibility of the mouth 122, providing a uniform exterior for the product.

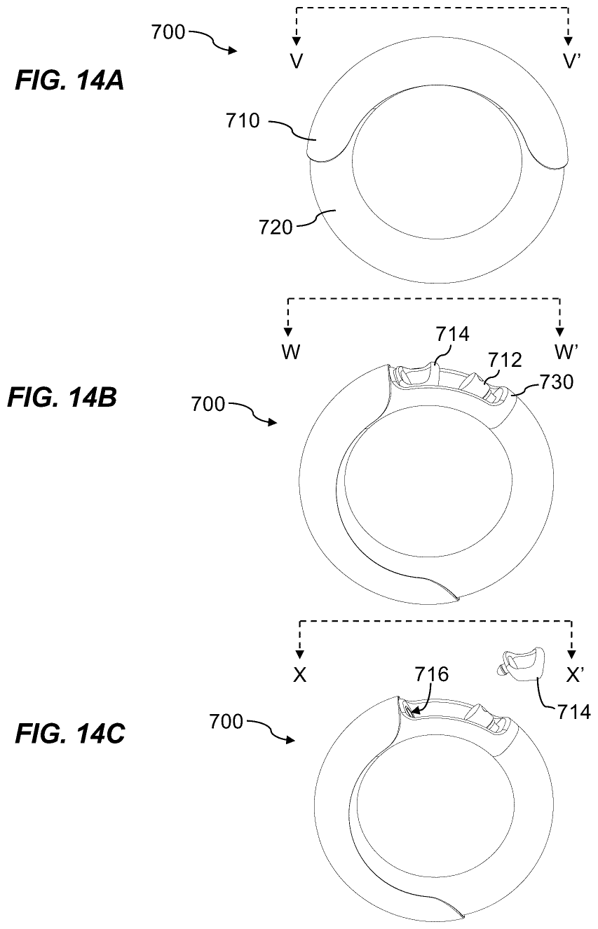

In various embodiments, other configurations of an integrated liquid container are contemplated. In the embodiment shown in FIG. 7, for example, the liquid container 226 corresponds to the internal size, shape, and profile of the housing 210. In such embodiments, the liquid container 226 comprises a general U-shape that extends along three perimeter edges of the housing 210 and the internal edge defined by the circumference of the through-hole 212. In some embodiments, as shown in FIGS. 1 and 7, the liquid container 226 comprises the mouth 222 at a first end though which a volume of liquid can be added or removed to fill or empty the liquid container. In such embodiments, the liquid container 226 comprises the corresponding removeable cap 224, and the mouth 222 is configured to receive the removeable cap 224. The mouth 222 can be removably coupled to the removeable cap 224 using any suitable means. In this context, a suitable coupling requires a liquid-tight seal while the mouth 222 is coupled to the removeable cap 224, and further allows the user to remove and reseal the removeable cap 224 without any specialized tool. In some embodiments, for example, the mouth 222 comprises a threaded external surface that is configured to couple with a corresponding threaded internal surface of the removeable cap 224 (i.e., a screw cap). Other suitable couplings are contemplated. For example, one of skill in the art would appreciate that other suitable closures can be implemented, including, for example, snap on closures, friction fit closures, sports cap style closures, bail closures, bung type closures, etc. In some embodiments, when secured in place, the removeable cap 224 obscures entirely the mouth 222, providing a uniform exterior for the product.

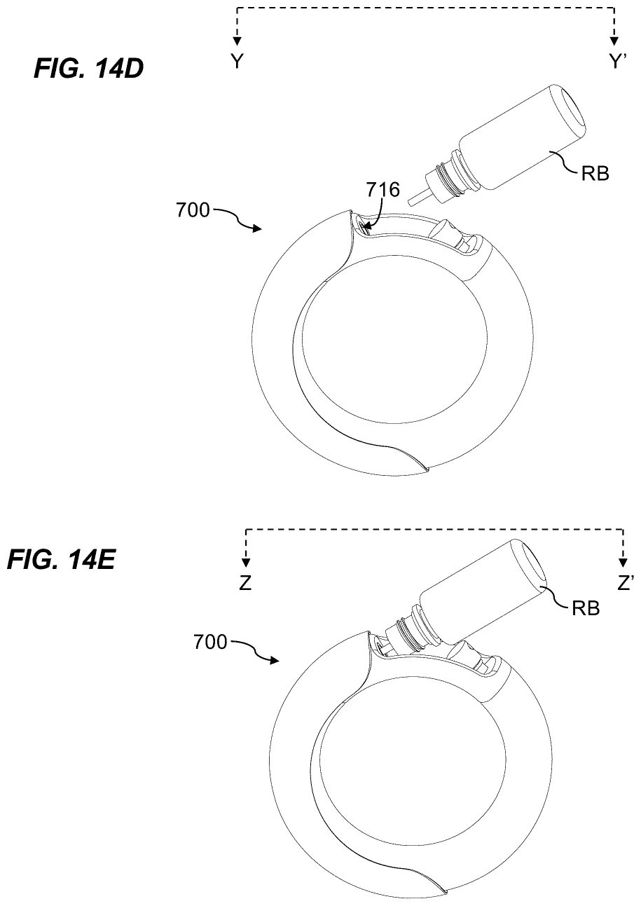

In some embodiments, the accessory 100 comprises the actuator 114. In some embodiments, as shown in FIGS. 2-6, 8, and 13, the actuator 114 comprises a solid three dimensional generally block-like structure having an outward facing surface that is accessible to the user via the top surface 115 of the accessory 100. In such embodiments, the outward facing surface of the actuator 114 is sized and shaped as a push button that is capable of being pressed inward by a user's finger, as illustrated in FIG. 8. In some embodiments, the actuator 114 comprises an upper portion comprising the outward facing surface, a central portion, and a lower portion having inward facing surface opposition the outward facing surface. In some embodiments, the actuator 114 the lower portion comprises the channel 117 for receiving the spraying mechanism 130 projecting out from a second end of the liquid container 126. In some embodiments, the spraying mechanism 130 is coupled to the dip tube 128, which is an elongated tubular structure configured to draw liquid out of the liquid container 126. The dip tube 128 can be any suitable length, whereby the suitability is based on the ability of the spraying mechanism 130 to draw liquid out of the liquid container 126 through the dip tube 128. In some embodiments, the channel 117 extends within the actuator 114 from an opening in the bottom, inward facing surface of the actuator 114 (i.e., the internal surface facing the liquid container 126) to an adjacent side surface facing the nozzle opening 116, which is formed on the surface 119 of the front side the accessory 100. In some embodiments, as shown in FIG. 6, for example, the spraying mechanism 130 projects outward and upward from the liquid container 126 toward and into the channel 117 in the actuator 114. In such embodiments, the channel 117 extends from the bottom side to an adjacent side of the actuator 114. During use, the channel 117 is in proximity to the nozzle opening 116.

In some embodiments, as shown in FIGS. 1, 2, 6-8, and 13, for example, the nozzle opening 116 is recessed within the front surface/side of the accessory 100. In such embodiments, the recessed structure of the nozzle opening 116 prevents any direct contact between a user or object and the spraying mechanism 130. In such embodiments, the components of the spraying mechanism 130 are protected from being contacted and/or contaminated by a user or object. In such embodiments, the recessed structure of the nozzle opening 116 prevents the spraying mechanism 130 from catching or being entangled with, and potentially damaging, an item of object such as clothing, bags, keys, phones, etc.

In some embodiments, as depicted in FIGS. 6 and 8, when the user depresses the actuator 114 with a finger, the actuator 114 slidably moves within the internal structure of the accessory 100. In such embodiments, the bottom inward facing surface of the actuator 114 contacts the external surface 131 of the spraying mechanism 130. In some embodiments, depressing the actuator 114 causes an increase of the pressure in the spray mechanism 130, and the pressure can then be dissipated by releasing an atomized spray of the liquid through the nozzle opening 116. In this context, an “atomized spray” or “atomization” refers to reducing the liquid to minute particles or to a fine spray. The spraying mechanism 130 can be any suitable liquid and/or mist sprayer. In some embodiments, the spraying mechanism 130 is a mist sprayer comprising a housing, housing cap, piston, spring, stem, seal, gasket, etc. In such embodiments, the mist sprayer can be coupled to the liquid container 126 and the dip tube 128. One skilled in the art would appreciate that during use, the user depresses the actuator 114 downward, as shown in FIG. 8, which causes liquid contained in the liquid container 126 to be drawn through the dip tube 128 to the interior of the sprayer housing. Subsequent actuation will pump the liquid upward through the piston toward the actuator 114 and then exit out of the nozzle opening 116. One skilled in the art would appreciate that alternative mechanisms for producing an atomized spray may be implemented in the accessory 100 without departing from the scope of this disclosure.

In some embodiments, the accessory comprises a locking mechanism. For example, as shown in FIG. 7, the accessory 200 comprises the locking mechanism 232, which is integrated into the housing 210 and the actuator 214. In such embodiments, the locking mechanism 232 comprises the slidable lock 234 integrated into the housing 210, which is further configured with the impression 240 and the projection 242. In such embodiments, the housing 210 comprises the projection 238 and the actuator 214 comprises the impression 236. During use, when a user is locking the locking mechanism 232, the projection 242 slides into the impression 236 of the actuator 214 while the projection 238 simultaneously slides into the impression 240. After actuation of the locking mechanism 232, the projection 242 inserted into the impression 236 will prevent the actuator 214 from being depressed downward to actuate the spraying mechanism 230. In such embodiments, the locking mechanism 232 prevents the accessory 200 from spraying liquid, either intentionally or unintentionally.

In some embodiments, the accessory 100 comprises a light (e.g., LED light). In some embodiments, the light may be incorporated into the housing 110. In such embodiments, the accessory 100 may include a battery for powering the light, and the housing 110 would be configured to accommodate the light and battery. In such embodiments, the light would be readily usable by the user to assist in the unlocking of a door or other tasks at night or in low light environments.

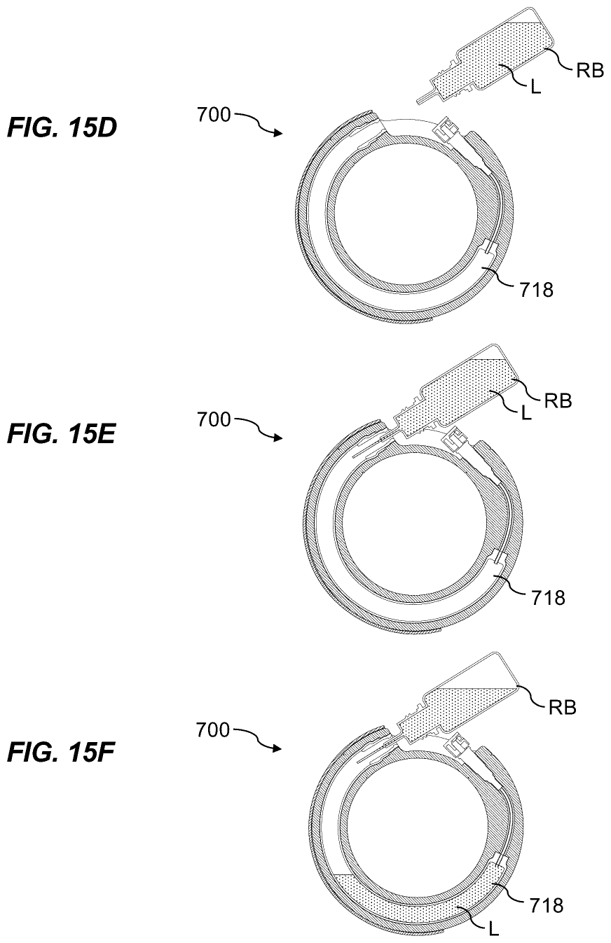

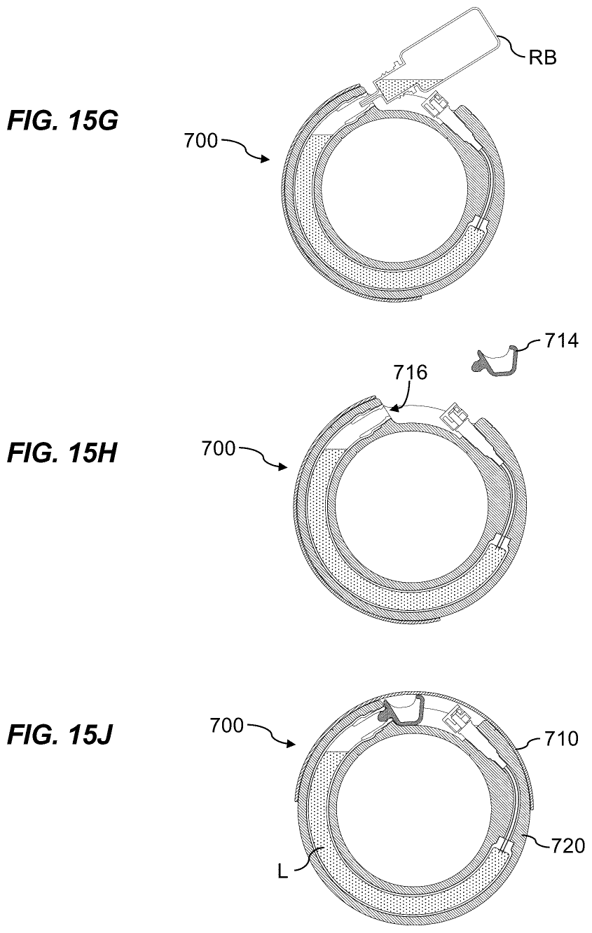

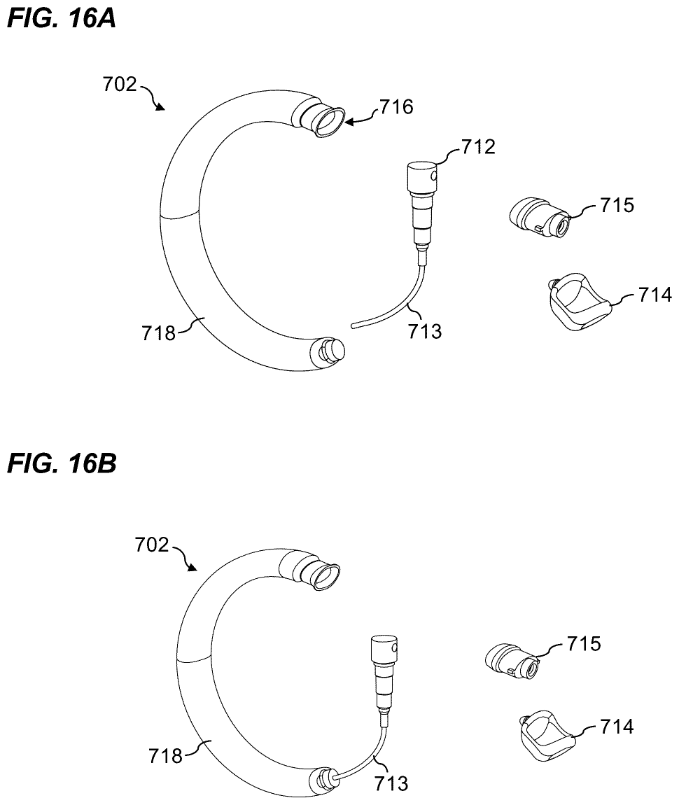

The wearable accessory can comprise any suitable shape and overall profile. Suitable shapes include, for example, the wearable accessory shown in FIGS. 9-12. In some embodiments, the wearable accessory comprises a circular shape, such as the accessory 300 in FIG. 9. In some embodiments, the wearable accessory comprises a substantially triangular shape, such as the accessory 400 in FIG. 10. In some embodiments, the wearable accessory comprises a substantially pentagonal shape, such as the accessory 500 in FIG. 11. In some embodiments, the wearable accessory comprises a substantially hexagonal shape, such as the accessory 600 in FIG. 12. One skilled in the art would appreciate that the accessories 300, 400, 500, and 600 can be configured with the same components as the accessories 100 or 200.

In various embodiments, the liquid container 126 is configured to hold and dispense any suitable sprayable liquid. In such embodiments, the liquid container 126 is fillable and refillable with the sprayable liquid. In some embodiments, for example, the accessory 100 can be used to spray liquid sanitizing solution (e.g., anti-bacterial solution), such as solutions comprising alcohol, benzalkonium chloride, etc., to prevent the spread of communicable diseases and otherwise improve personal hygiene. In some embodiments, the liquid container 126 is configured to hold sprayable liquids, including, for example, perfume or fragrances, insect (e.g., mosquito) repellent, pepper spray, sunscreen, medicine, etc.

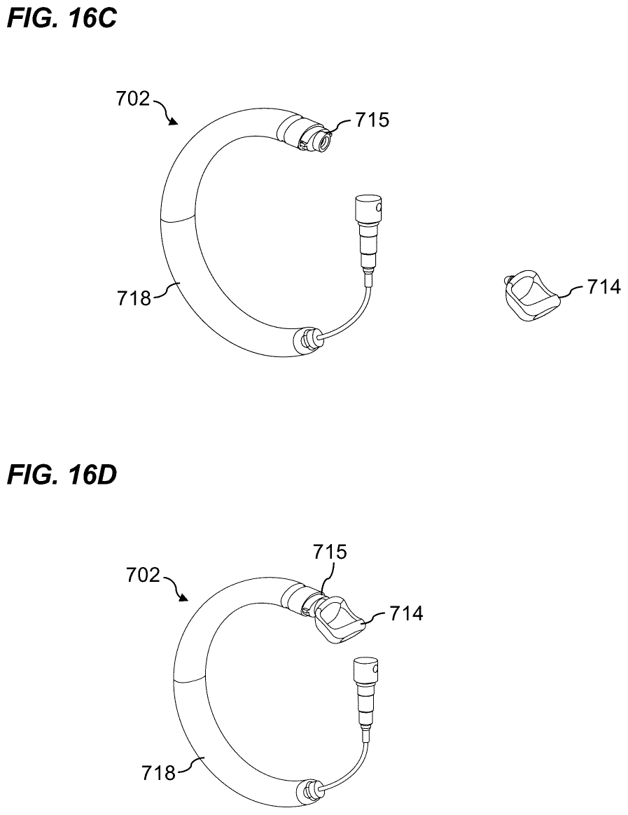

During use, the accessory may be used to spray surfaces, such as those the user may encounter (e.g., door handles, steering wheel, faucets, elevator buttons). Alternatively, the accessory may be used to spray the user's hands, neck, wrists, ankles, or other exposed skin, clothing, etc., depending on the liquid contained. The accessory 100 may be used while being worn by the user without disassembly or modification, as shown in FIG. 13, or it can be removed from the user before dispersing the liquid contained therein.

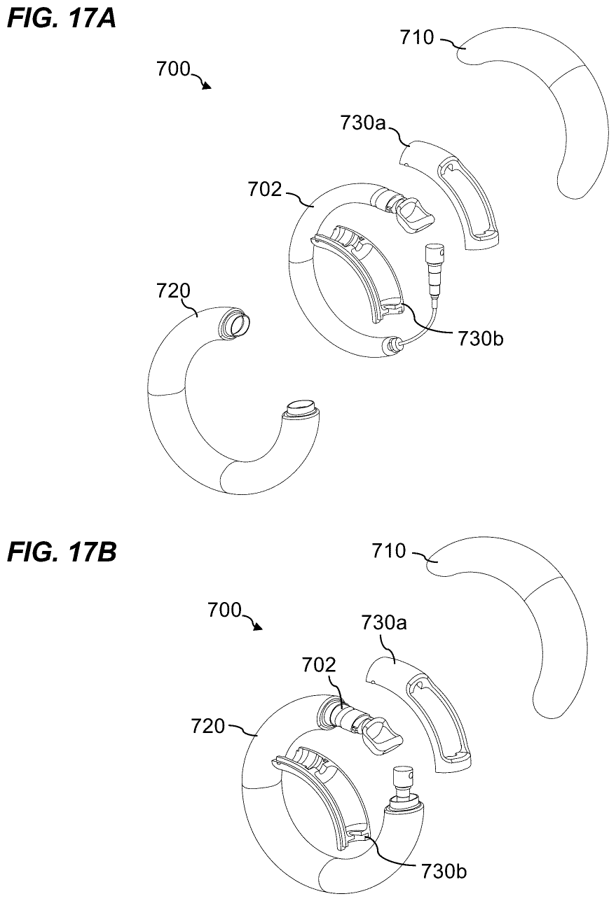

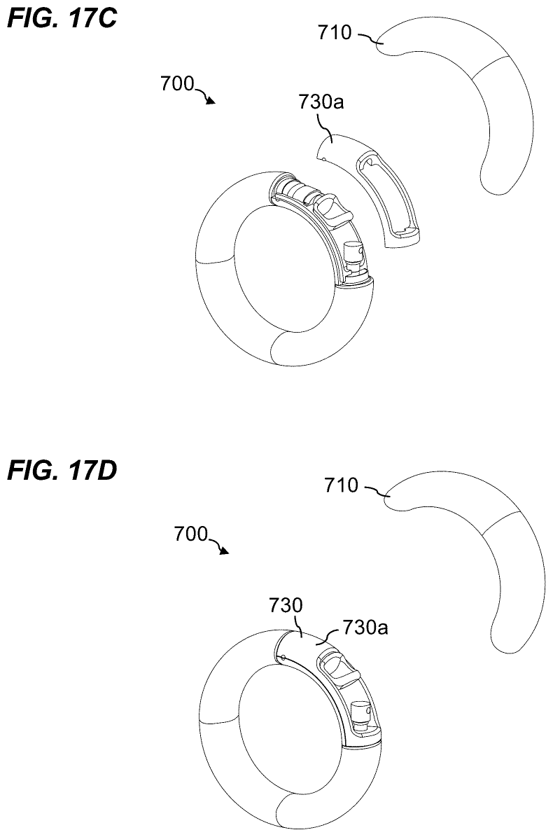

In various embodiments, as shown in FIG. 14A, FIG. 14B, FIG. 14C, FIG. 14D, and FIG. 14E, side views of a wearable accessory 700 is provided. In FIG. 15A, FIG. 15B, FIG. 15C, FIG. 15D, FIG. 15E, FIG. 15F, FIG. 15G, FIG. 15H, and FIG. 15J, cross-sectional views of the wearable accessory 700 are provided. The figures further show a method of refilling the wearable accessory 700.

In various embodiments, as shown in the figures, the wearable accessory 700 comprises a wearable housing 720 and a slidable cover 710. In some embodiments, the slidable cover 710 is configured to slide about an exterior surface of the wearable housing 720. In FIG. 14A, the slidable cover 710 is in a closed position and the internal components are concealed from view. In FIG. 14B, the slidable cover 710 is in an open position and the internal components are exposed. In some embodiments, as shown in FIG. 14B, the wearable housing 720 comprises a recess tray 730. In such embodiments, the recess tray 730 is configured to provide access to a sprayer 712 at one end of a liquid container 718 and a sealable opening 716 at an opposite end of the liquid container 718.

As shown in the cross-sectional views, the wearable accessory 700 comprises the liquid container 718 having the sprayer 712 at one end and the sealable opening 716 at an opposite end. In some embodiments, the liquid container 718 has a structure that is independent from the structure of the wearable housing. In such embodiments, the liquid container 718 is fully enclosed within an internal space defined by the wearable housing 720. In some embodiments, the liquid container 718 comprises a first end having a sealable opening 716 for adding liquid, and a second end in fluid communication with a sprayer 712 recessed in the wearable housing.

In some embodiments, the wearable accessory 700 comprises a removable closure (e.g., plug) 714 that is configured to seal the sealable opening 716. In FIG. 14B and FIG. 15B the slidable cover 710 is in an open position and the sprayer 712 and the closure 714 can be accessed by a user. During use, a user can actuate the sprayer 712 and actuating the sprayer will cause a portion of a volume of liquid stored inside the liquid container 718 to exit an opening in the sprayer. In some embodiments, the wearable accessory 700 comprises a dip tube 713 that provides fluid communication between the sprayer 712 and the liquid container 718.

In some embodiments, as shown in FIG. 14C and FIG. 15C, the closure 714 is removed and the sealable opening 716 is accessible. In such embodiments, a user can refill the liquid container 718 with liquid. In FIG. 14D and FIG. 15D, a refill bottle RB is approaching the sealable opening 716. In FIG. 14E, a tip of the refill bottle RB is inserted into the sealable opening 716, and liquid can be transferred from the refill bottle RB to the liquid container 718. FIGS. 15E-15G illustrate the transfer of liquid from the refill bottle RB to the liquid container 718. FIG. 15H shows the closure 714 prior to being inserted into the sealable opening 716. FIG. 15J shows the liquid container 718 after being refilled, the closure 714 inserted into and sealing the sealable opening 716, and the slidable cover 710 is in the closed position.

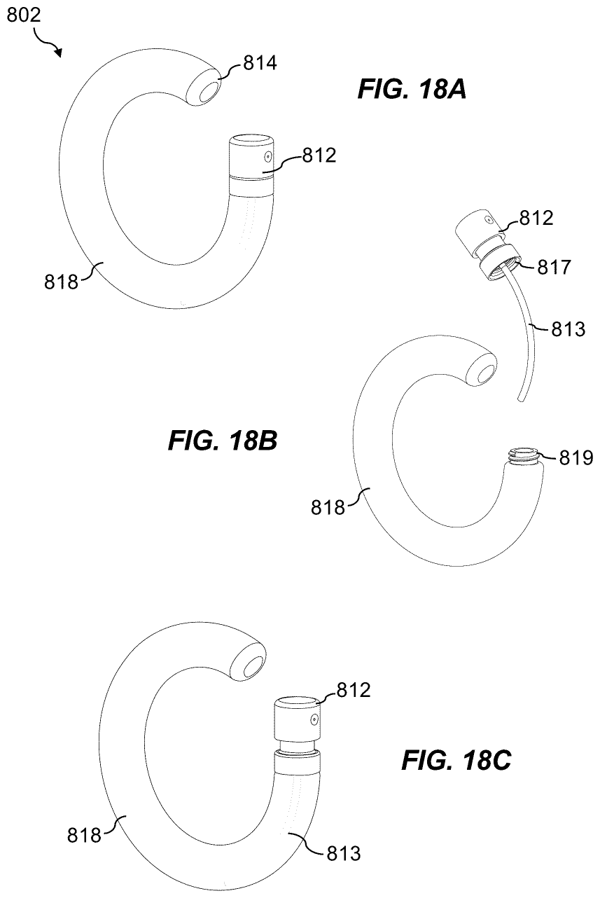

FIG. 16A, FIG. 16B, FIG. 16C, and FIG. 167D show an embodiment of a liquid storing and dispensing assembly 702. FIG. 16A shows an exploded view of the liquid storing and dispensing assembly 702, comprising the liquid container 718, the sprayer 712, the dip tube 713, the sealable opening 716, the closure 714, and an adapter 715. FIG. 16B shows a partially exploded view of the liquid storing and dispensing assembly 702, with the dip tube 713 inserted into a first end of the liquid container 718. FIG. 16C shows a partially exploded view of the liquid storing and dispensing assembly 702, with the dip tube 713 inserted into the first end of the liquid container 718 and the adapter 715 inserted into a second end of the liquid container 718. FIG. 16D shows the liquid storing and dispensing assembly 702 after assembly, with the dip tube 713 inserted into the first end of the liquid container 718, the adapter 715 inserted into a second end of the liquid container 718, and the closure 714 coupled to the adapter 715.

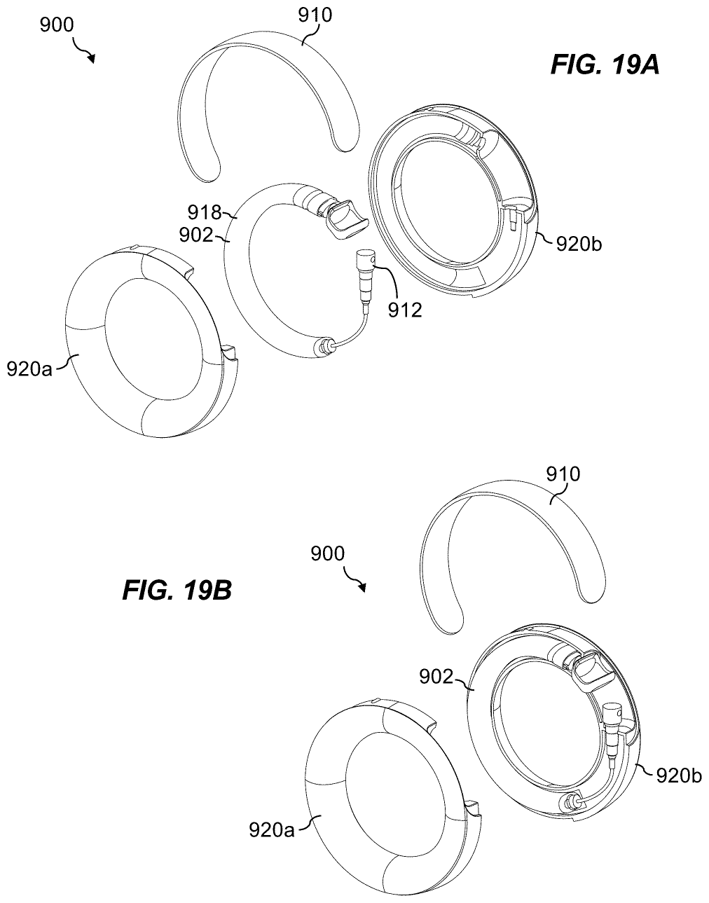

In various embodiments, the wearable housing 720 comprises a body 720 configured to receive the liquid storing and dispensing assembly 702, the body 720 having a first end and a second end, and a recess tray 730 for providing access to the sprayer 712 and the closure 714. In some embodiments, the recess tray 730 is comprised of a plurality of components. For example, as shown in the exploded view of FIG. 17A, the recess tray 730 comprises an upper component 730a and lower component 730b. In such embodiments, the upper component 730a and lower component 730b are coupled to one another and to the wearable housing 720 comprising the liquid storing and dispensing assembly 702.

FIG. 17B shows a partially exploded view of the wearable accessory 700, with the liquid storing and dispensing assembly 702 contained within the wearable housing 720. FIG. 17C shows a partially exploded view of the wearable accessory 700, with the liquid storing and dispensing assembly 702 contained within the wearable housing 720 and the lower component 730b coupled at opposite ends to the wearable housing 720. FIG. 17D shows a partially exploded view of the wearable accessory 700, with the liquid storing and dispensing assembly 702 contained within the wearable housing 720, and both the lower component 730b and the upper component 730a coupled at opposite ends to the wearable housing 720.

The components of the wearable accessory 700 can be any suitable material, including, for example, silicone, plastic, glass, metal, metal alloy, etc. The metal can be, for example, aluminum. The metal alloy can be, for example, stainless steel or an aluminum alloy. In some embodiments, for example, the wearable housing 720 is made out of metal or a metal alloy. In some embodiments, for example, the wearable housing 720 is made out of a combination of materials, including a metal or a metal alloy and a plastic. For example, the wearable housing 720 and the slidable cover 710 can be made from a metal or metal alloy and the recess tray 730 can be made from plastic.

The liquid storing and dispensing assembly can be comprised of any suitable material, including, for example, silicone, plastic, glass, metal, metal alloy, etc. The suitability of the material, in some embodiments, depends on the nature of the liquid. If the liquid is hand sanitizer comprising an alcohol, then the material of the liquid storing and dispensing assembly must be suitable for storing alcohol.

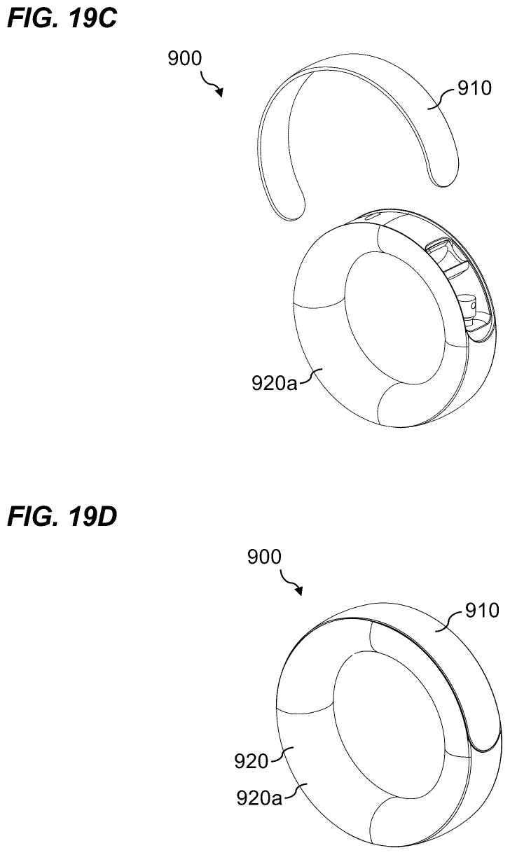

In some embodiments, as shown in FIG. 18A, FIG. 18B, and FIG. 18C, the wearable accessory comprises a liquid storing and dispensing assembly 802 that is configured with a sprayer 812. In some embodiments, the sprayer 812 comprises threads 817 and is coupled to a liquid container 818 having corresponding reverse threads 819. In some embodiments, the sprayer 812 is coupled to the liquid container 818 using a friction fitting or snap coupling (i.e., without threads). In some embodiments, the liquid container 818 is blow molded into a specific shape. In some embodiments, the liquid storing and dispensing assembly 802 omits the sealable opening and instead has a sealed end opposite the sprayer 812. In such embodiments, the liquid container 818 is refilled by removing the sprayer 812, inserting liquid, and then reattaching the sprayer 812.

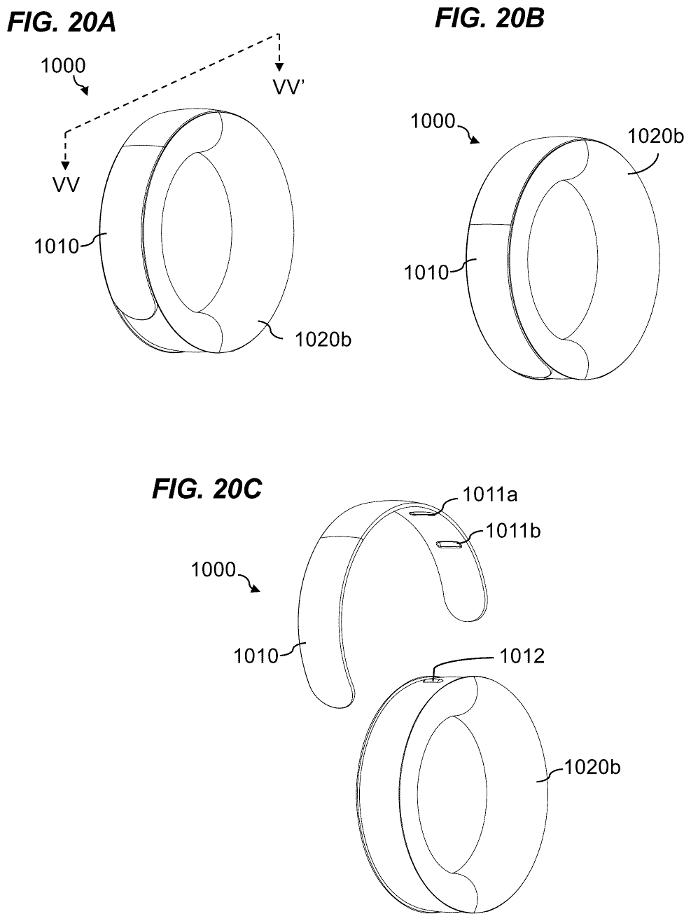

In some embodiments, the wearable housing is comprised of multiple components that are assembled to one another to form a unitary wearable housing. In FIG. 19A, FIG. 19B, FIG. 19C, and FIG. 19D, for example, the wearable accessory 900 comprises a wearable housing 920 that is comprised of a first housing component 920a and a second housing component 920b that are coupled together to form the wearable housing 920. FIG. 19A is an exploded view of the wearable accessory 900 showing a slidable cover 910, a liquid storing and dispensing assembly 902, the first housing component 920a, and the second housing component 920b. FIG. 19B is a partially exploded view showing the liquid storing and dispensing assembly 902 embedded within an internal space defined by the second housing component 920b. FIG. 19C is a partially exploded view showing the liquid storing and dispensing assembly 902 embedded within an internal space defined by the first housing component 920a and the second housing component 920b. FIG. 19D shows the assembled wearable accessory 900.

In some embodiments of the wearable accessory 900, the liquid storing and dispensing assembly 902 comprises a silicone liquid container 918, plastic housing components 920a, 920b, and a plastic slidable cover 910. In such embodiments, the silicone liquid container 918 is enclosed between the plastic housing components 920a, 920b, which are joined using glue, a weld, or one-way snaps.

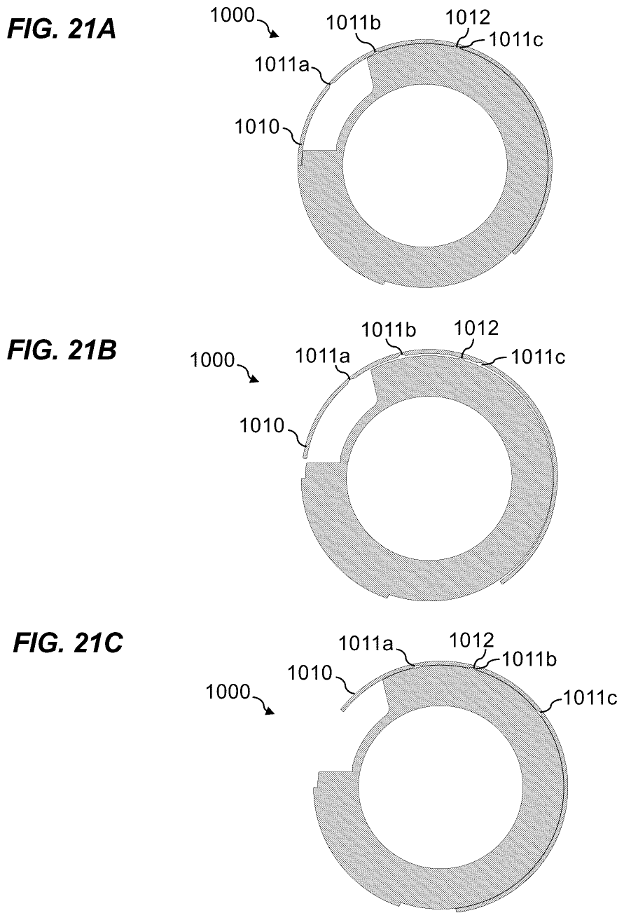

In some embodiments, the wearable assembly comprises a combination of one or more detents and one or more indents that are configured to control the movement of a slidable cover about a wearable housing. FIG. 20A, FIG. 20B, and FIG. 20C, for example, show a wearable assembly 1000. In some embodiments, as shown in FIG. 20B, the wearable assembly 1000 comprises a slidable cover 1010 and a wearable housing 1020. In some embodiments, as shown in FIG. 20C, the wearable housing 1020 comprises a detent 1012 on an external surface that is configured to engage with a plurality of indents 1011a, 1011b on an interior side (i.e., the side that is coupled to the wearable housing 1020) of the slidable cover 1010. During use, after assembly, the slidable cover 1010 can be slid around the wearable housing 1020 until the detent 1012 mates with one of the indents 1011a, 1011b, which will temporarily arrest the slidable cover 1010 in a stable position (e.g., open position, closed position).

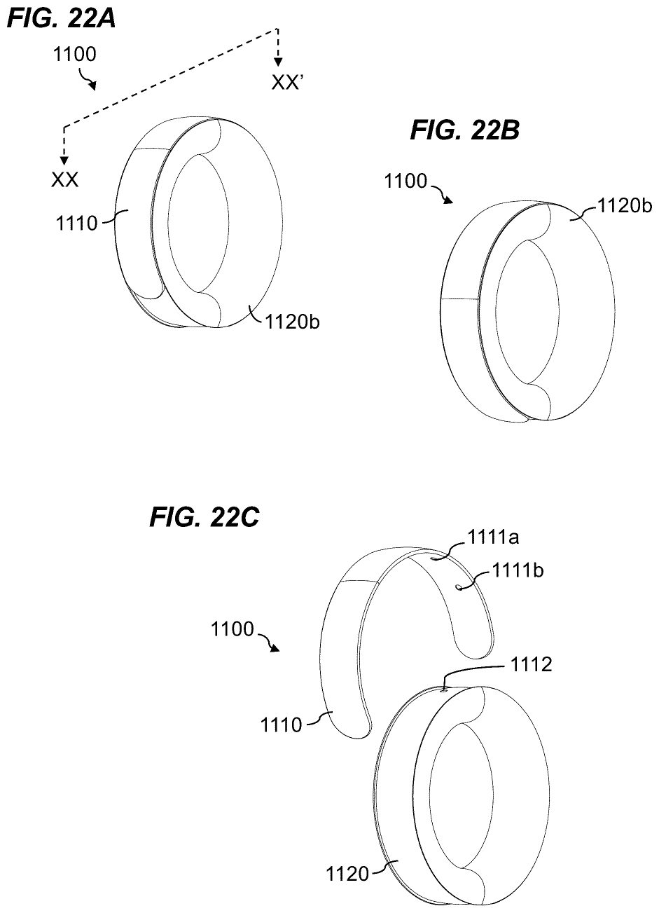

FIG. 21A, FIG. 21B, and FIG. 21C are cross-sectional views of the wearable assembly 1000. FIG. 21A shows the slidable cover 1010 in a closed position in which the detent 1012 on the surface of the wearable housing 1020 is engaged with a corresponding indent 1011c on the interior surface of the slidable cover 1010. FIG. 21B shows the slidable cover 1010 in a partially open position in which the detent 1012 on the surface of the wearable housing 1020 is not engaged with a corresponding indent 1011c on the interior surface of the slidable cover 1010. As shown in FIG. 21B, there is a spaced distance between the slidable cover 1010 and the wearable housing 1020, which allows the slidable cover 1010 to slide. FIG. 21C shows the slidable cover 1010 in an intermediate position between the open and closed positions in which the detent 1012 on the surface of the wearable housing 1020 is engaged with a corresponding indent 1011b on the interior surface of the slidable cover 1010. When the detent 1012 is engaged with the indent 1011b, the slidable cover 1010 is in a stable position and temporarily prevented from sliding about the wearable housing.

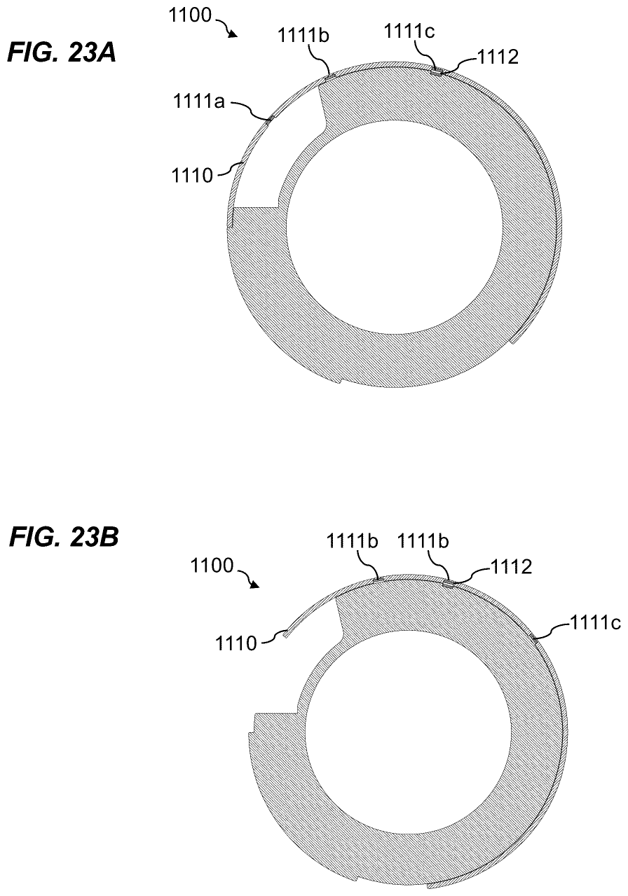

In some embodiments, the wearable assembly comprises a combination of one or more magnets that are configured to control the movement of a slidable cover about a wearable housing. FIG. 22A, FIG. 22B, and FIG. 22C, for example, show a wearable assembly 1100. In some embodiments, as shown in FIG. 22B, the wearable assembly 1100 comprises a slidable cover 1110 and a wearable housing 1120. In some embodiments, as shown in FIG. 22C, the wearable housing 1120 comprises a magnet or ferromagnetic material (collectively, “magnet”) 1112 on an external surface that is configured to engage with a plurality of magnets 1111a, 1111b on an interior side (i.e., the side that is coupled to the wearable housing 1120) of the slidable cover 1110. During use, after assembly, the slidable cover 1110 can be slid around the wearable housing 1120 until the magnet 1112 mates with one of the magnets 1111a, 1111b, which will temporarily arrest the slidable cover 1110 in a stable position (e.g., open position, closed position).

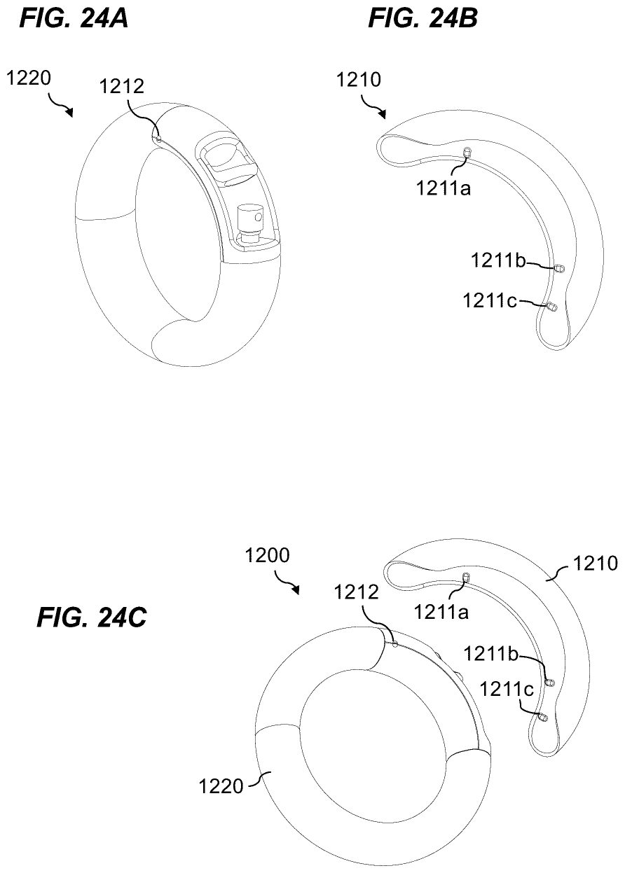

FIG. 23A and FIG. 23B are cross-sectional views of the wearable assembly 1100. FIG. 23A shows the slidable cover 1110 in a closed position in which the magnet 1112 on the surface of the wearable housing 1120 is engaged with a corresponding magnet 1111c on the interior surface of the slidable cover 1110. FIG. 23B shows the slidable cover 1110 in an intermediate position between the open and closed positions in which the magnet 1112 on the surface of the wearable housing 1120 is engaged with a corresponding magnet 1111b on the interior surface of the slidable cover 1110. When the magnet 1112 is engaged with the magnet 1111b or the magnet 1111c, the slidable cover 1110 is in a stable position and temporarily prevented from sliding about the wearable housing.

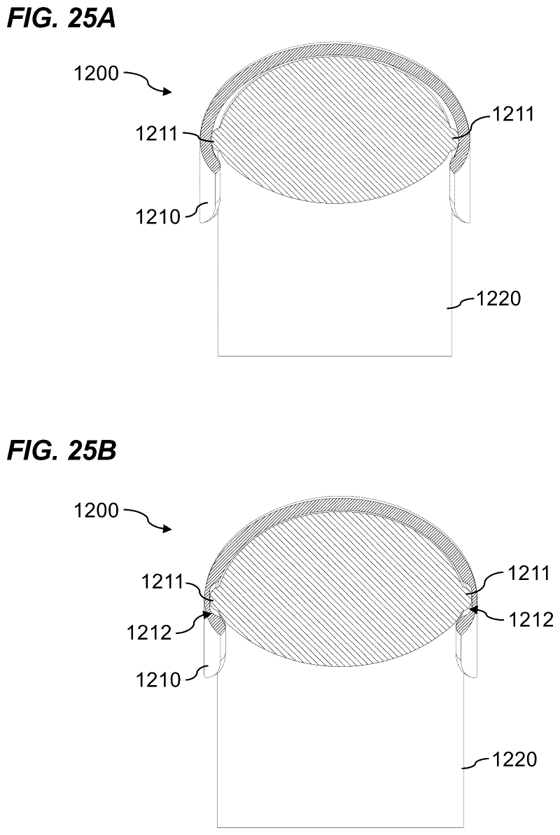

FIG. 24A, FIG. 24B, and FIG. 24C show another example of a wearable assembly having a plurality of detents for controlling and/or stabilizing the position of a slidable cover. In some embodiments, as shown in the figures, the wearable assembly 1200 comprises a slidable cover 1210 and a wearable housing 1220. In some embodiments, the wearable housing 1220 comprises an indent 1212 on an external surface that is configured to engage with a plurality of detents 1211a, 1211b on an interior side (i.e., the side that is coupled to the wearable housing 1220) of the slidable cover 1210. During use, the slidable cover 1210 can be slid around the wearable housing 1220 until one of the detents 1211a, 1211b mates with the indent 1212, which will temporarily arrest the slidable cover 1210 from sliding further and maintain the slidable cover in a stable position (e.g., open position, closed position).

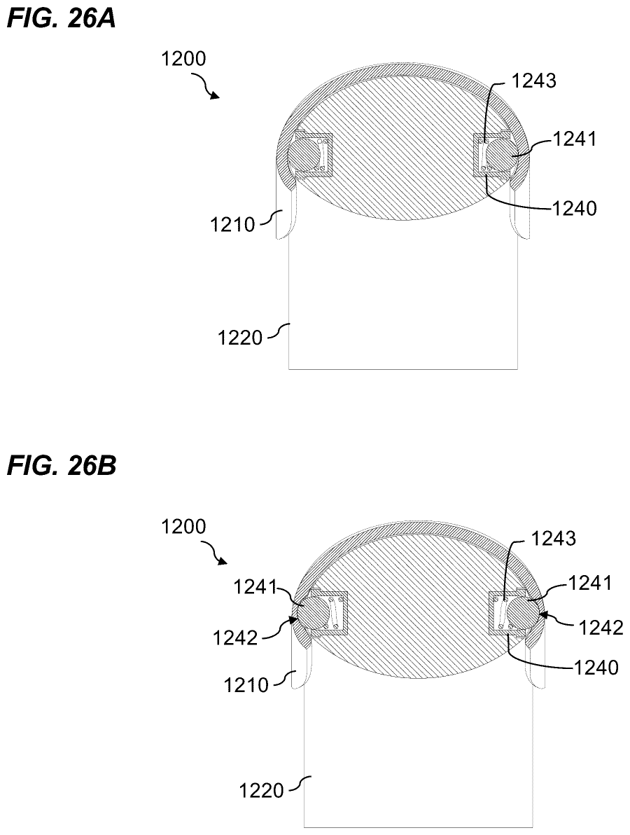

FIG. 25A is a partial cross-sectional view showing the detents 1211 on the wearable housing 1220 disengaged from any indents on the interior surface of the slidable cover 1210. As shown in the figure, then the detents are not engaged with the indents, the detents forcibly push the interior surface of the slidable cover 1210 away from the exterior surface of the wearable housing 1220 to create a spaced distance therebetween. FIG. 25B is a partial cross-sectional view showing the detents 1211 on the wearable housing 1220 engaged with the indents 1212 on the interior surface of the slidable cover 1210. When the detents are engaged with the indents, the slidable cover 1210 is maintained in a stable position and prevented from sliding around the wearable housing 1220.

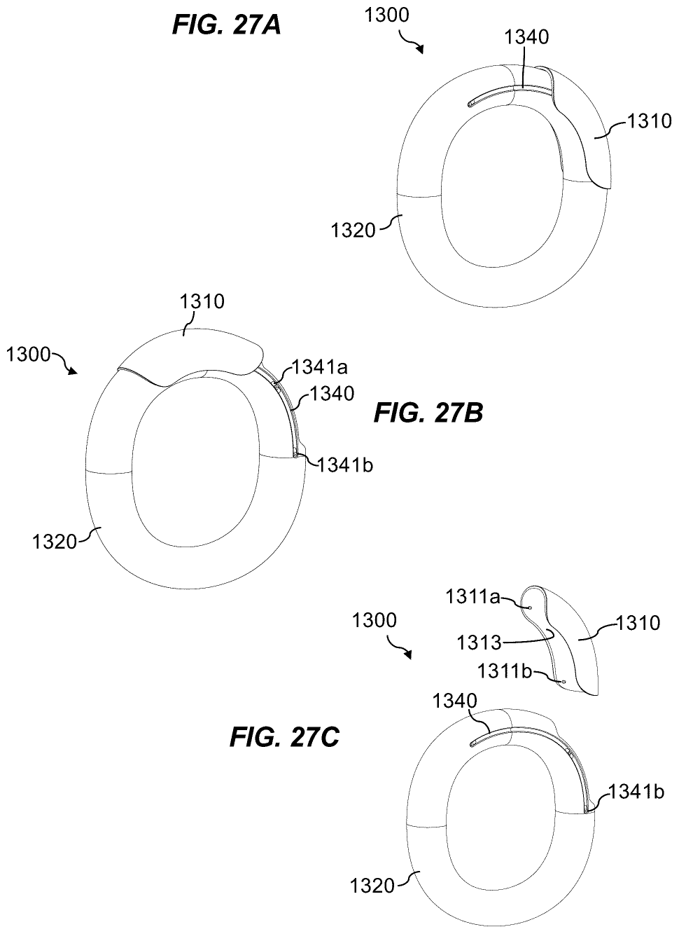

The detents described herein can be of any suitable configuration, including a solid protrusion that projects out from a surface, as shown in FIG. 25A and FIG. 25B. During use, the slidable cover must receive a force that causes the structure to flex in order to disengage from the detents. Alternative detents are also contemplated. In some embodiments, as shown in FIG. 26A and FIG. 26B, the detents are spring loaded projections.

FIG. 26A is a partial cross-sectional view showing the detents 1241 on the wearable housing 1220 disengaged from any indents on the interior surface of the slidable cover 1210. As shown in the figure, when the detents are not engaged with the indents, the interior surface of the slidable cover 1210 forcibly pushes the detents 1241 inward, which causes the springs 1243 to compress within the detent housing 1240. FIG. 26B is a partial cross-sectional view showing the detents 1241 within the detent housing 1240 engaged with the indents 1242 on the interior surface of the slidable cover 1210. When the detents 1241 are engaged with the indents 1242, the springs 1243 are less compressed within the detent housing 1240, and the slidable cover 1210 is maintained in a stable position and prevented from sliding around the wearable housing 1220.

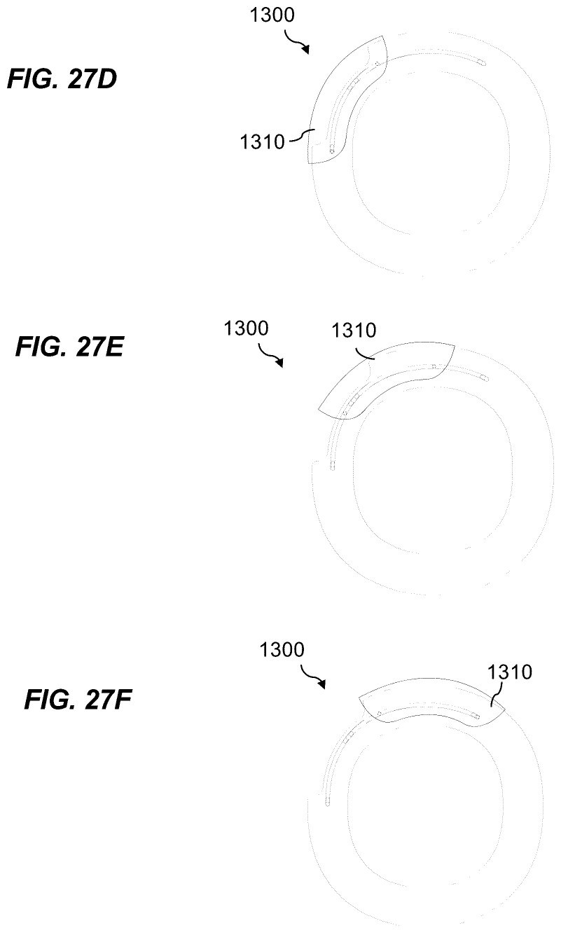

In various embodiments, as shown in FIG. 27A, FIG. 27B, FIG. 27C, FIG. 27D, FIG. 27E, and FIG. 27F, a wearable accessory 1300 is provided. In some embodiments, the wearable accessory 1300 comprises a wearable housing 1320 and a slidable cover 1310. The wearable housing 1320 comprises a track 1340 that is defined by a curved groove in one or both sides of the wearable housing 1320. The slidable cover 1310 comprises an interior surface 1313 having one or more pins (e.g., 1311a, 1311b) projecting therefrom. In some embodiments, the one or more pins are configured to fit within and engage the track 1340 of the wearable housing 1320. In some embodiments, the track 1340 comprises one or more detents 1341a, 1341b that are configured to hold the pins in position when the slidable cover 1310 is in a closed position, intermediate position, or in an open position. One advantage of this embodiment is the track 1340 is usable for a wearable housing 1320 having a shape that is not circular. For a non-circular shaped wearable housing 1320, the slidable cover 1310 will follow a curved path defined by the track 1340, and the pins will ride along the track and to navigate the curvature.

In various embodiments, as shown in FIG. 27D, FIG. 27E, and FIG. 27F, the slidable cover 1310 is configured to move between a closed position shown in FIG. 27D, an intermediate position shown in FIG. 27E, and an open position shown in FIG. 27F. In some embodiments, when the slidable cover 1310 is in the closed position, a user cannot access the sprayer or closure/sealable opening; when the slidable cover 1310 is in the intermediate position, the user can access the sprayer but cannot access the closure/sealable opening; and when the slidable cover 1310 is the closed position, the user can access both the sprayer and the closure/sealable opening. In such embodiments, the intermediate position is the dispensing position and the open position is the refilling position.

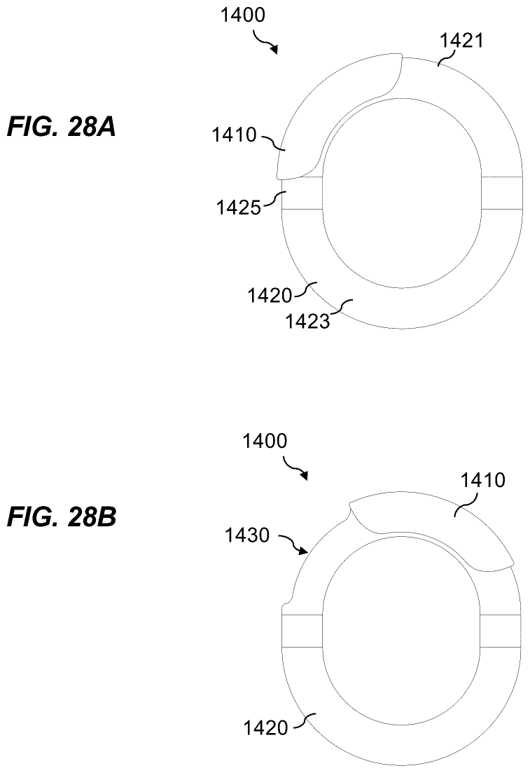

In various embodiments, as shown in FIG. 28A, FIG. 28B, FIG. 28C, and FIG. 28D a wearable accessory 1400 is provided. In some embodiments, the wearable accessory 1400 comprises a wearable housing 1420 and a slidable cover 1410. The wearable housing 1420 comprises an oval shape featuring a semi-circular upper portion 1421, a semi-circular lower portion 1423, and vertical portions 1425 connecting opposite ends of the upper and lower portions. FIG. 28A and FIG. 28C show the slidable cover 1410 in a closed position. FIG. 28B shows the slidable cover 1410 in an open position, which reveals the recess 1430, which is wear a sprayer and closure are concealed by the housing. FIG. 28D shows a partially exploded view with the slidable cover 1410 removed from the wearable housing 1420. In some embodiments, the slidable cover 1410 comprises a plurality of detents (e.g. 1411a, 1411b, 1411c) configured to engage with the wearable housing 1420. In some embodiments, the vertical portion 1425 is functional because it has a linear cross-sectional shape that prevents the slidable cover 1410, which has a semi-circular cross-sectional shape, from sliding. As such, during use, the vertical portion 1425 limits the slidable cover 1410 to a slide a maximum of 180 degrees about the semi-circular upper portion 1421.

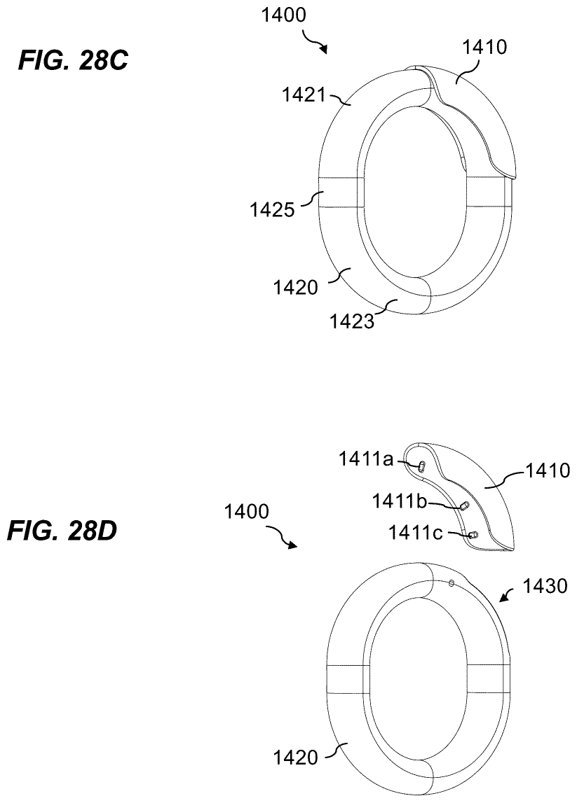

In various embodiments, as shown in FIG. 29A, FIG. 29B, and FIG. 29C, a wearable accessory 1500 is provided. In some embodiments, the wearable accessory 1500 comprises a wearable housing 1520, a slidable cover 1510, and a lock 1540. In such embodiments, the lock 1540 is configured to secure the slidable cover 1510 to the wearable housing 1520. In FIG. 29A, the lock 1540 is engaged (locked) and the slidable cover 1510 cannot be slid about the wearable housing 1520. In FIG. 29B, the lock 1540 is disengaged (unlocked) and the slidable cover 1510 can slide about the wearable housing 1520. In FIG. 29C, the slidable cover 1510 has been slid about the wearable housing 1520 to reveal a sprayer 1512 recessed within the wearable housing 1520. As shown in FIG. 29C, the lock 1540 comprises a latch 1542, which engages a corresponding latch (now shown) on an interior surface of the slidable cover 1510.

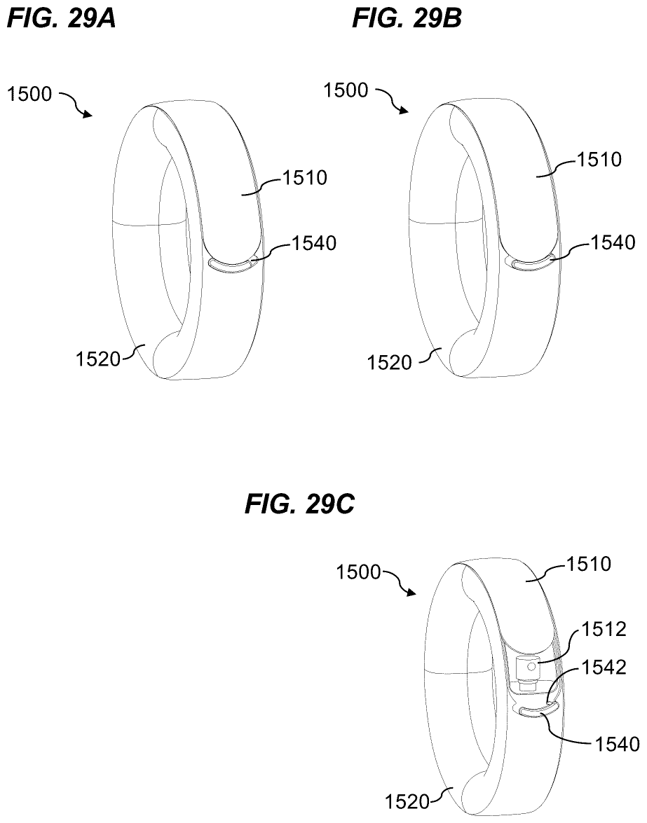

In various embodiments, as shown in FIG. 30A and FIG. 30B, a friction cover 1610 is provided. In some embodiments, a foam pad 1605 is attached to an interior surface 1613 of the friction cover 1610. The foam pad 1605 can have a small thickness and is configured to create friction when the cover 1610 slidably moves about a wearable housing of a wearable accessory. In some embodiments, the foam pad 1605 comprises an adhesive on a first side for coupling to the interior surface 1613 of the friction cover 1610. During use, the foam pad 1605 is compressed between the friction cover 1610 and the wearable housing of the wearable accessory, which creates friction as the cover slides about the housing. In some embodiments, the relative amount of friction can be adjusted by increasing or decreasing the thickness of the foam pad 1605 and/or increasing or decreasing the level of compression provided by the foam.

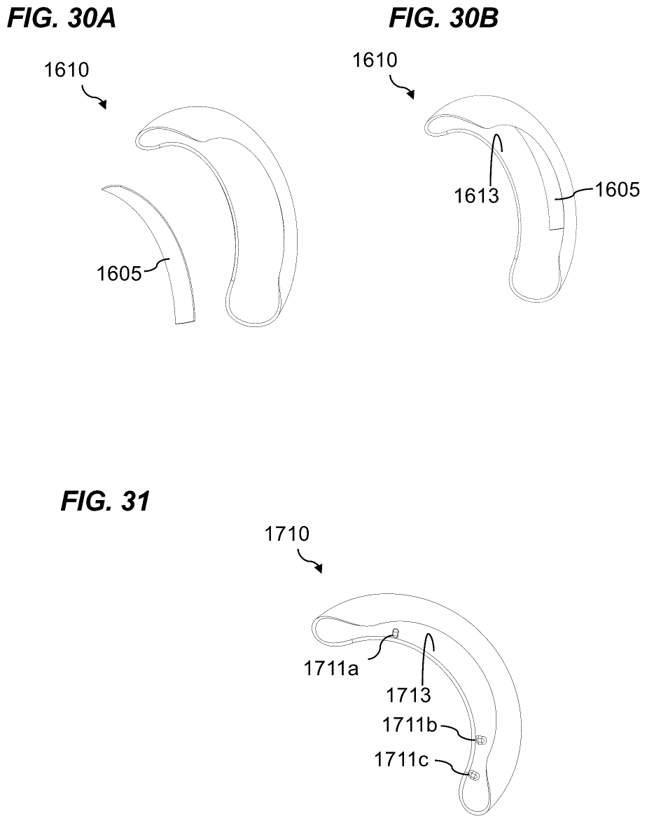

In various embodiments, as shown in FIG. 31, a locking cover 1710 is provided. In some embodiments, the locking cover 1710 comprises a plurality of detents on an interior surface 1713. In some embodiments, the geometry of the detents can be adjusted to make sliding the locking cover 1710 about a wearable housing either easier (i.e., less resistance) or harder (i.e., more resistance). In some embodiments, a first detent 1711a comprises a relatively sharp surface transition, whereas the other detents such as a second detent 1711b and third detent 1711c comprise relatively gradual surface transitions. The sharp surface transition of the first detent 1711a will require more force to overcome than the gradual surface transitions of the second and third detents 1711b, 1711c. During use, the different surface transitions of the detents provide haptic feedback to the user. For example, the haptic feedback provided by the sharp transition of the detent causes the user to perceive the locking cover 1710 as being robustly locked in place when the locking cover 1710 is in the closed position on a wearable housing.

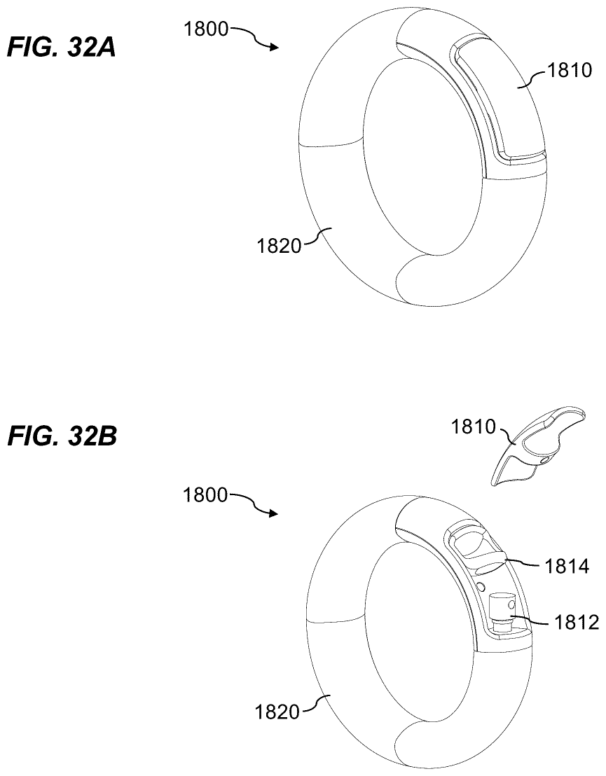

In various embodiments, as shown in FIG. 32A and FIG. 32B, a wearable accessory 1800 is provided. In some embodiments, the wearable accessory 1800 comprises a wearable housing 1820 and a magnetic cover 1810. In FIG. 32A, the magnetic cover 1810 is in a closed position, and an external surface of the wearable accessory 1800 appears as a circular loop. In FIG. 32B, the magnetic cover 1810 is in an open or released position, which reveals a sprayer 1812 and a closure 1814, each of which being in fluid communication with opposite ends of a liquid container enclosed within the wearable housing 1820. In some embodiments, each of the magnetic cover 1810 and the wearable housing 1820 comprise a magnet or ferromagnetic material, in complementary positions, that allow the components to be removably fastened to one another such that the magnetic cover 1810 can be pulled away from the wearable housing 1820, as shown in FIG. 32B. During use, a user can pull off the magnetic cover 1810 to access the sprayer 1812 and apply liquid from the liquid container to a surface, or to access and remove the closure 1814 in order to refill the liquid container via a sealable opening sealed by the closure.

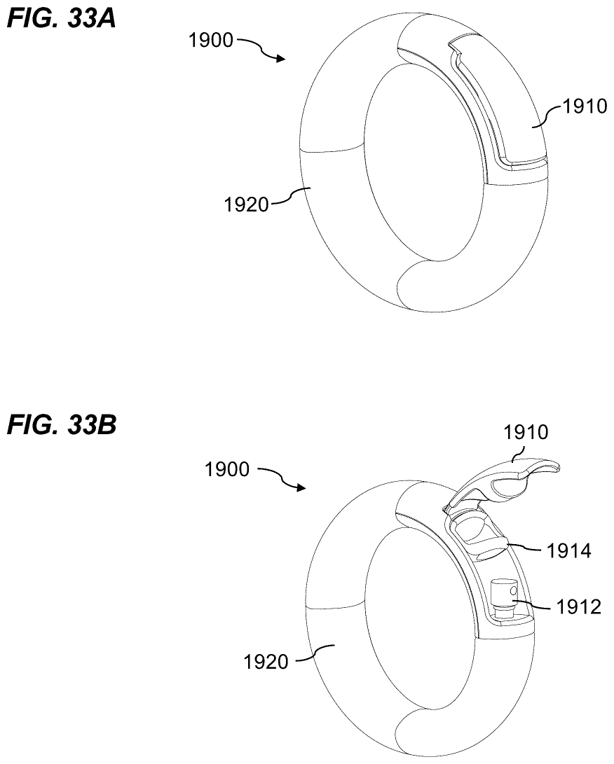

In various embodiments, as shown in FIG. 33A and FIG. 33B, a wearable accessory 1900 is provided. In some embodiments, the wearable accessory 1900 comprises a wearable housing 1920 and a hinged cover 1910. In FIG. 33A, the hinged cover 1910 is in a closed position, and an external surface of the wearable accessory 1900 appears as a circular loop. In FIG. 33B, the hinged cover 1910 is in an open position, which reveals a sprayer 1912 and a closure 1914, each of which being in fluid communication with opposite ends of a liquid container enclosed within the wearable housing 1920. In some embodiments, the hinged cover 1910 is fastened to the wearable housing 1920 at a first end (proximate to the closure 1914) with a hinge, which allows a second end of the hinged cover 1910 (proximate to the sprayer 1912) to move upward and away from the wearable housing 1920, as shown in FIG. 33B. During use, a user can open the hinged cover 1910 to access the sprayer 1912 and apply liquid from the liquid container to a surface, or to access and remove the closure 1914 in order to refill the liquid container via a sealable opening sealed by the closure.

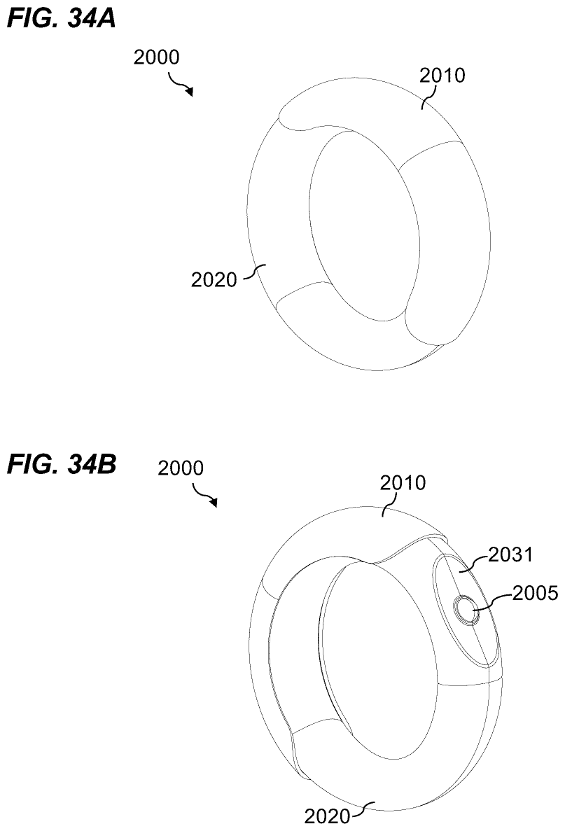

In various embodiments, as shown in FIG. 34A and FIG. 34B, a wearable accessory 2000 is provided. In some embodiments, the wearable accessory 2000 comprises a wearable housing 2020 and a slidable cover 2010. In FIG. 34A, the slidable cover 2010 is in a closed position, and an external surface of the wearable accessory 2000 appears as a circular loop. In FIG. 34B, the slidable cover 2010 is in an open position, which reveals a roller applicator 2005. In some embodiments, the roller applicator 2005 is positioned in a recess 2031 that was concealed by the slidable cover 2010. In some embodiments, the roller applicator 2005 is in fluid communication with liquid container enclosed within the wearable housing 2020. During use, the roller applicator 2005 is pressed against the skin of a user, which causes the release a small amount of liquid onto the skin.

In various embodiments, the wearable accessory 100, 200, 300, 400, 500, 600, 700, 900, 1000, 1100, 1200, 1300, 1400, 1500, 1600, 1700, 1800, 1900, or 2000 is an article of apparel, such as a piece of fashionable unisex jewelry, including, for example a bracelet, which includes a discretely integrated spray bottle. Although some embodiments herein are depicted as a bracelet, one skilled in the art would appreciate that the wearable accessory can be reconfigured into other jewelry devices, such as anklets, wristbands, wristwatches, necklaces, pendants, etc.

The components (e.g., housing, liquid container) of the wearable accessory described herein can be independently comprised of any suitable material. In some embodiments, for example, one or more components of the wearable accessory is comprised of one or more plastic compositions. In such embodiments, the composition can comprise a phenolic, polycarbonate, polypropylene, acrylic, Bakelite, celluloid, or Lucite, component. In some embodiments, for example, one or more components of the wearable accessory is comprised of one or more milled or cast metal or metal alloys. In some embodiments, one or more components of the wearable accessory is comprised of wood, metal, metal alloy, glass, stone, gem, etc. In some embodiments, the wearable accessory is comprised of a single, unitary piece of material. In other embodiments, the wearable accessory is comprised of a plurality of pieces that are assembled to form a unitary device.

Exemplary embodiments of the wearable accessory are described above in detail. The wearable accessory is not limited to the specific embodiments described herein, but rather, components of the wearable accessory may be utilized independently and separately from other components described herein. For example, the wearable accessory may also be used in combination with other devices.

Although specific features of the present embodiments may be shown in some drawings and not in others, this is for convenience only. In accordance with the principles of the disclosure, any feature of a drawing may be referenced and/or claimed in combination with any feature of any other drawing.

This written description uses examples to disclose the present embodiments, including the best mode, and also to enable any person skilled in the art to practice the present embodiments, including making and using the wearable accessory. The patentable scope of the present embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

I/we claim:

1. A wearable accessory for storing and dispensing liquid, comprising:
a wearable housing comprising a through-hole configured to receive a hand of a user therethrough, the through-hole being sized for the user's lower arm;
a liquid container having a structure independent from the wearable housing, and enclosed within an internal space defined by the wearable housing, the liquid container comprising a first end having a sealable opening for adding liquid for the storing and dispensing, and a second end in fluid communication with a sprayer recessed in the wearable housing; and
a closure configured to seal the sealable opening on the first end of the liquid container; and
a recess cover adapted for the wearable housing and configured to move between a closed position that conceals the sprayer and the closure and an open position that allows access to the sprayer and the closure.

2. The wearable accessory of claim 1, wherein the recess cover is a slidable cover that is configured to slide along an external surface of the wearable housing between the closed position and the open position.

3. The wearable accessory of claim 2, wherein the slidable cover comprises one or more detents projecting from an internal surface facing the wearable housing when assembled, and the wearable housing comprises one or more indents configured to receive the one or more detents when the slidable cover slides between the closed position and the open position.

4. The wearable accessory of claim 2, wherein the wearable housing comprises one or more detents projecting from a surface facing the slidable cover when assembled, and the slidable cover comprises one or more indents configured to receive the one or more detents when the slidable cover slides between the closed position and the open position.

5. The wearable accessory of claim 2, wherein the wearable housing comprises a generally circular or oval cross-sectional shape and the slidable cover comprises a generally semi-circular cross-sectional shape.

6. The wearable accessory of claim 1, wherein the recess cover comprises one or more magnets or ferromagnetic materials;
wherein the wearable housing comprises one or more magnets or ferromagnetic materials; and
wherein the recess cover is in the closed position when the one or more magnets or ferromagnetic materials on the recess cover are in contact with the one or more magnets or ferromagnetic materials on the wearable housing, and in the open position when the one or more magnets or ferromagnetic materials on the recess cover are not in contact with the one or more magnets or ferromagnetic materials on the wearable housing.

7. The wearable accessory of claim 1, wherein the recess cover is coupled to the wearable housing with a hinge, and the recess cover pivots about the hinge between the closed position and the open position.

8. The wearable accessory of claim 1, wherein the liquid container comprises a shape adapted for the wearable housing, whereby the liquid container is immobilized within the wearable housing due to its positioning between a plurality of perimeter edges on the wearable housing.

9. The wearable accessory of claim 1, wherein the sprayer comprises a dip tube for drawing the volume of liquid from the liquid container.

10. The wearable accessory of claim 1, wherein the recess cover comprises a shape corresponding to an external shape of the wearable housing and the recess cover is coupled to the wearable housing using compression forces provided by the shape of the recess cover.

11. The wearable accessory of claim 1, wherein the recess cover comprises a shape corresponding to an external shape of the wearable housing, and the recess cover is coupled to the wearable housing using a combination of magnets or ferromagnetic materials, a combination of detents and indents configured to receive the detents, a combination of detents and a channel configured to receive the detents, or a hinge.

12. The wearable accessory of claim 1, wherein the recess cover is configured to move between the closed position, the open position, and an intermediate position that allows access to the sprayer but not the closure.

13. The wearable accessory of claim 1, further comprising a lock integrated into the wearable housing, wherein the lock is movable from a locked position to an unlocked position, and wherein the locked position prevents the recess cover from moving from the closed position to the open position.

14. A wearable accessory for storing and dispensing liquid, comprising:
a wearable housing comprising a through-hole configured to receive a hand of a user therethrough, the through-hole being sized for the user's lower arm;
a liquid container having a structure independent from the wearable housing, and enclosed within an internal space defined by the wearable housing, the liquid container comprising a first end having a sealable opening for adding liquid for the storing and dispensing, and a second end in fluid communication with a sprayer recessed in the wearable housing; and
a closure configured to seal the sealable opening on the first end of the liquid container; and
a slidable cover adapted for the wearable housing and configured to slide about an external surface on the wearable housing between a closed position that conceals the sprayer and the closure and an open position that allows access to the sprayer and the closure.

15. The wearable accessory of claim 14, wherein the recess cover is configured to move between the closed position, the open position, and an intermediate position that allows access to the sprayer but not the closure.

16. A method of applying a liquid to a surface, comprising:
providing a wearable accessory for storing and dispensing a liquid, the wearable accessory comprising:
a wearable housing comprising a through-hole configured to receive a hand of a user therethrough, the through-hole being sized for the user's lower arm;
a liquid container having a structure independent from the wearable housing, and enclosed within an internal space defined by the wearable housing, the liquid container comprising a first end having a sealable opening for adding liquid for the storing and dispensing, and a second end in fluid communication with a sprayer recessed in the wearable housing;
a volume of liquid stored inside the liquid container; and
a closure configured to seal the sealable opening on the first end of the liquid container; and
a recess cover adapted for the wearable housing and configured to move between a closed position that conceals the sprayer and the closure and an open position that allows access to the sprayer and the closure;
moving the recess cover to the open position;
directing an opening in the sprayer toward the surface; and
actuating the sprayer to cause a portion of the volume of liquid stored inside the liquid container to exit the opening in the sprayer.

17. The method of claim 16, wherein the wearable accessory further comprises a dip tube that provides fluid communication between the sprayer and the liquid container.

18. The method of claim 16, wherein the recess cover is a slidable cover that is configured to slide along an external surface of the wearable housing between the closed position and the open position.

19. The method of claim 18, wherein the recess cover comprises a shape corresponding to an external shape of the wearable housing, and the recess cover is coupled to the wearable housing using a combination of magnets or ferromagnetic materials, a combination of detents and indents configured to receive the detents, a combination of detents and a channel configured to receive the detents, or a hinge.

20. The method of claim 15, wherein the wearable accessory further comprises a lock integrated into the wearable housing, wherein the lock is movable from a locked position to an unlocked position, and wherein the locked position prevents the recess cover from moving from the closed position to the open position.
